(19) United States
(12) Patent Application Publication
(10) Pub. No.: US 2023/0344129 A1
(43) Pub. Date: Oct. 26, 2023

(54) ANTENNA SYSTEM AND ELECTRONIC DEVICE

(71) Applicant: GUANGDONG OPPO MOBILE TELECOMMUNICATIONS CORP., LTD., Dongguan (CN)

(72) Inventor: Xiaopu WU, Dongguan (CN)

(73) Assignee: GUANGDONG OPPO MOBILE TELECOMMUNICATIONS CORP., LTD., Dongguan (CN)

(21) Appl. No.: 18/341,563

(22) Filed: Jun. 26, 2023

Related U.S. Application Data
(63) Continuation of application No. PCT/CN2021/130984, filed on Nov. 16, 2021.

(30) Foreign Application Priority Data
Dec. 29, 2020 (CN) 202011608758.5
Dec. 29, 2020 (CN) 202023287937.1

(51) Int. Cl. H01Q 5/357; H01Q 5/335

(52) U.S. Cl. CPC H01Q 5/357; H01Q 5/335

(57) ABSTRACT

The present application provides an antenna system and an electronic device. The antenna system includes at least two antenna assemblies and a control unit. Each antenna assembly includes a first antenna; the first antenna includes a first radiator, a first signal source, a first matching circuit, and a first adjusting circuit; the first radiator has a first feed point; the first signal source is electrically connected to the first matching circuit and the first feed point; the first adjusting circuit is electrically connected to the first radiator or the first matching circuit, and is configured to adjust a resonant frequency point of the first antenna, so that the first antenna supports transceiving of an electromagnetic wave signal of at least one of an LTE low frequency band and an NR low frequency band.

### CROSS-REFERENCE TO RELATED APPLICATIONS

The present application is a continuation of International (PCT) Patent Application No. PCT/CN2021/130984 filed on Nov. 16, 2021, which claims priorities to Chinese patent application No. 202023287937.1, filed on Dec. 29, 2020, and Chinese patent application No. 202011608758.5, filed on Dec. 29, 2020, the contents of all of which are hereby incorporated by reference.

### TECHNICAL FIELD

The present disclosure relates to the technical field of communications, in particular to an antenna system and an electronic device.

### BACKGROUND

With the development of technology, the popularity of electronic devices with communication functions such as mobile phones are increasing, and their functions are becoming increasingly powerful. The electronic device usually includes an antenna system so as to realize the communication function of the electronic device. However, in the related technology, the communication performance of the antenna system in the electronic device is not good enough, and the space to be promoted still exists.

### SUMMARY OF THE DISCLOSURE

In a first aspect, the present disclosure provides an antenna system. The antenna system includes at least two antenna assemblies and a control unit. Each antenna assembly includes a first antenna including a first radiator, a first signal source, a first matching circuit and a first adjusting circuit. The first radiator has a first feed point. The first signal source is electrically connected to the first feed point through the first matching circuit. The first adjusting circuit is electrically connected to the first radiator or the first matching circuit, and is configured to adjust a resonant frequency point of the first antenna, so that the first antenna supports transceiving of electromagnetic wave signals in a first frequency band range. The first frequency band range includes at least one of an LTE low frequency band range and an NR low frequency band range. The control unit is configured to control the first antenna of one antenna assembly to support the LTE low frequency band, and control the first antenna of the other antenna assembly to support the NR low frequency band, so as to implement the ENDC of the LTE low frequency band and the NR low frequency band.

In a second aspect, the present disclosure provides an electronic device, and the electronic device includes the antenna system of the first aspect.

### BRIEF DESCRIPTION OF THE DRAWINGS

In order to more clearly illustrate the technical solutions of the embodiments of the present disclosure, the accompanying drawings, which are intended to be used in embodiments, will be briefly described. Obviously, the drawings described below are some embodiments of the present disclosure, and for those of ordinary skill in the art, without creative effort, other drawings may be obtained according to these drawings.

FIG. 1 is a schematic view of an antenna system according to an embodiment of the present disclosure.

FIG. 2 is a schematic view of an antenna assembly in the antenna system of FIG. 1.

FIG. 3 is a schematic view of an antenna system according to another embodiment of the present disclosure.

FIG. 4 is a schematic view of an antenna assembly according to another embodiment of the present disclosure.

FIG. 5 is a schematic view of an antenna assembly according to another embodiment of the present disclosure.

FIG. 6 is a schematic view of an antenna assembly according to an embodiment of the present disclosure.

FIG. 7 is a table of transceiving of electromagnetic wave signals supported by the antenna assembly according to an embodiment of the present disclosure.

FIG. 8 is a schematic view of an antenna assembly according to another embodiment of the present disclosure.

FIG. 9 is an equivalent schematic view that the first adjusting circuit in FIG. 8 implements the low impedance of the second frequency band range and the third frequency band range to ground.

FIG. 10 is a schematic illustration of a simulation of some S parameters of the antenna assembly of FIG. 6.

FIG. 11 is a schematic view of a first adjusting circuit according to an embodiment of the present disclosure.

FIG. 12 is a schematic view of the first adjusting circuit according to another embodiment of the present disclosure.

FIG. 13 is a simulation diagram of the first adjusting circuit for switching a frequency band supported by a first antenna in a first frequency band range.

FIG. 14 is a schematic view of an antenna assembly according to another embodiment of the present disclosure.

FIG. 15 is a schematic view of a second adjusting circuit according to an embodiment of the present disclosure.

FIG. 16 is a schematic view of a second adjusting circuit according to an embodiment of the present disclosure.

FIG. 17 is a schematic simulation diagram of the antenna assembly of FIG. 14.

FIG. 18 is a schematic view of an antenna assembly according to yet another embodiment of the present disclosure.

FIG. 19 is a schematic view of an antenna assembly according to yet another embodiment of the present disclosure.

FIG. 20 is a schematic view of an antenna assembly according to yet another embodiment of the present disclosure.

FIG. 21 is a schematic view of an antenna assembly according to yet another embodiment of the present disclosure.

FIG. 22 is a schematic view of an antenna assembly according to yet another embodiment of the present disclosure.

FIG. 23 is a schematic view of the size of a gap between a first radiator and a second radiator in an antenna assembly according to an embodiment of the present disclosure.

FIG. 24 is a three-dimensional schematic view of an electronic device according to an embodiment of the present disclosure.

FIG. 25 is a cross-sectional schematic view of the line I-I of FIG. 24 according to an embodiment of the present disclosure.

FIG. 26 is a schematic view of an electronic device according to an embodiment of the present disclosure.

FIG. 27 is a schematic view of an antenna system in an electronic device according to another embodiment of the present disclosure.

FIG. 28 is a schematic illustration of the position of an antenna system in an electronic device according to another embodiment of the present disclosure.

### DETAILED DESCRIPTION

In a first aspect, the present disclosure provides an antenna system. The antenna system includes at least two antenna assemblies and a control unit. Each antenna assembly includes a first antenna including a first radiator, a first signal source, a first matching circuit and a first adjusting circuit. The first radiator has a first feed point. The first signal source is electrically connected to the first feed point through the first matching circuit. The first adjusting circuit is electrically connected to the first radiator or the first matching circuit, and is configured to adjust a resonant frequency point of the first antenna, so that the first antenna supports transceiving of electromagnetic wave signals in a first frequency band range. The first frequency band range includes at least one of an LTE low frequency band range and an NR low frequency band range. The control unit is configured to control the first antenna of one antenna assembly to support the LTE low frequency band, and control the first antenna of the other antenna assembly to support the NR low frequency band, so as to implement the ENDC of the LTE low frequency band and the NR low frequency band.

In some embodiments, the antenna system includes four antenna assemblies. The control unit is also configured to control one of two antenna assemblies in the four antenna assemblies to support the same LTE low frequency band, or control two antenna assemblies in the four antenna assemblies to jointly support the same LTE low frequency band; and control one of the other two antenna assemblies in the four antenna assemblies to support the same NR low frequency band, or control the other two antenna assemblies in the four antenna assemblies to jointly support the same NR low frequency band.

In some embodiments, the control unit is configured to adjust the first adjusting circuit of at least one first antenna in the two antenna assemblies, thereby adjusting the LTE low frequency band commonly supported by the two antenna assemblies. The control unit is further configured to adjust the first adjusting circuit of at least one first antenna in the other two antenna assemblies, to adjust the NR low frequency band commonly supported by the other two antenna assemblies, such that the antenna system supports a first ENDC combination, a second ENDC combination, and a third ENDC combination. The control unit is further configured to control the antenna system to switch between the first ENDC combination, the second ENDC combination, and the third ENDC combination.

In some embodiments, the first ENDC combination includes B20+N28, the second ENDC combination includes B20+N8, the third ENDC combination includes B28+N5.

In some embodiments, the first radiator has a first free end and a first grounding end opposite to first free end. The first radiator also includes a first connection point, the first feed point and the first connection point are spaced apart from each other between the first free end and the first grounding end. When the first adjusting circuit is electrically connected to the first radiator, the first adjusting circuit is electrically connected to the first connection point.

In some embodiments, the first connection point is located between the first free end and the first feed point; alternatively, the first connection point is located between the first grounding end and the first feed point.

In some embodiments, each antenna assembly further includes a second antenna. The second antenna includes a second radiator, a second signal source, a second matching circuit and a third radiator. The second radiator and the first radiator are spaced apart from each other and coupled to each other. The second radiator has a second feed point, and the second signal source is electrically connected to the second feed point through the second matching circuit. The third radiator is electrically connected to the second matching circuit, the second antenna is configured to support transceiving of the electromagnetic wave signals in a second frequency band range and a third frequency band range. The second frequency band range includes an MHB frequency band, and the third frequency band range includes a UHB frequency band.

In some embodiments, the antenna system includes four antenna assemblies. The control unit is configured to control the four antenna assemblies to realize Carrier aggregation CA of the MHB frequency band and the MHB frequency band, or 4*4 MIMO of ENDC of the MHB frequency band and the UHB frequency band.

In some embodiments, the second antenna further includes a second adjusting circuit, the second adjusting circuit is electrically connected to the second radiator or the second matching circuit, and the second adjusting circuit is configured to adjust the resonant frequency point of the second antenna.

In some embodiments, the second radiator has a second free end and a second grounding end opposite to the second free end. The second free end and the first radiator are spaced apart from each other and coupled to each other. The second radiator further includes a second connection point. The second feed point and the second connection point are spaced apart from each other between the second free end and the second grounding end. When the second adjusting circuit is electrically connected to the second radiator, the second adjusting circuit is electrically connected to the second connection point.

In some embodiments, the second connection point is located between the second free end and the second feed point. Alternatively, the second connection point is located between the second feed point and the second grounding end.

In some embodiments, the antenna system has a first resonance mode, a second resonance mode, a third resonance mode and a fourth resonance mode, to cover the transceiving of the electromagnetic wave signals in the second frequency band range and the third frequency band range.

In some embodiments, at least one of the first resonance mode, the second resonance mode, the third resonance mode, and the fourth resonance mode is generated by the third radiator.

In some embodiments, when one end of the first adjusting circuit is grounded, and the other end is connected to the first connection point, the first resonance mode is generated from the second grounding end to the second free end of the second radiator. The second resonance mode is generated from the first connection point of the first adjusting circuit and the first radiator to the first free end. The third resonance mode is generated from the second feed point of the second radiator to the second free end, and the third radiator generates the fourth resonance mode.

In some embodiments, the first resonance mode is the fundamental mode that the second antenna operates from the second grounding end of the second radiator to the second free end. The second resonance mode is the fundamental mode that the first antenna operates from the first connection point of the first adjusting circuit and the first radiator to the first free end. The third resonance mode is the fundamental mode that the second antenna operates from the second feed point of the second radiator to the second free end. The fourth resonance mode is the fundamental mode that the second antenna operates in the third radiator.

In some embodiments, when one end of the first adjusting circuit is grounded, and the other end is connected to the first connection point, the fundamental mode from the second grounding end to the second free end of the second radiator generates the first resonance mode; the fundamental mode from the first connection point of the first adjusting circuit and the first radiator to the first free end generates the second resonance mode; the fundamental mode from the second feed point of the second radiator to the second free end generates the third resonance mode; and the high order mode from the first connection point of the first adjusting circuit and the first radiator to the first free end generates the fourth resonance mode.

In a second aspect, the present disclosure provides an electronic device including the antenna system according to any one of the first aspect.

In some embodiments, the electronic device includes a plurality of sides which are sequentially connected end to end, and each antenna assembly is arranged corresponding to different sides.

In some embodiments, the electronic device includes a first side, a second side, a third side and a fourth side which are sequentially connected end to end. The first side is opposite to and spaced apart from the third side, and the second side is opposite to and spaced apart from the fourth side. The first antenna of the antenna assembly corresponding to the first side and the first antenna of the antenna assembly corresponding to the third side are adjacent to the second side. Alternatively, the first antenna of the antenna assembly corresponding to the first side and the first antenna of the antenna assembly corresponding to the third side are adjacent to the fourth side. Alternatively, the first antenna of the antenna assembly corresponding to the first side is adjacent to the second side, and the first antenna of the antenna assembly corresponding to the third side is adjacent to the fourth side. Alternatively, the first antenna of the antenna assembly corresponding to the first side is adjacent to the fourth side, and the first antenna of the antenna assembly corresponding to the third side is adjacent to the second side.

In some embodiments, the first antenna of the antenna assembly corresponding to the second side and the first antenna of the antenna assembly corresponding to the fourth side are adjacent to the first side. Alternatively, the first antenna of the antenna assembly corresponding to the second side and the first antenna of the antenna assembly corresponding to the fourth side are adjacent to the third side. Alternatively, the first antenna of the antenna assembly corresponding to the second side is adjacent to the first side, and the first antenna of the antenna assembly corresponding to the fourth side is adjacent to the third side. Alternatively, the first antenna of the antenna assembly corresponding to the second side is adjacent to the third side, and the first antenna of the antenna assembly corresponding to the fourth side is adjacent to the first side.

The following will be combined with the accompanying drawings in the embodiments of the present disclosure, the technical solutions in the embodiments of the present disclosure are clearly and completely described. Obviously, the described embodiments are merely a part of the embodiments of the present disclosure, and not all embodiments. Based on the embodiments in present disclosure, all other embodiments obtained by those of ordinary skill in the art without creative labor are within the scope of protection in present disclosure.

Reference herein to an “embodiment” means, particular features, structures, or characteristics described in connection with embodiments may be included in at least an embodiment of the present disclosure.

The phrase appearing in various positions in the specification does not necessarily refer to the same embodiment, nor is it an independent or alternative embodiment that is mutually exclusive with other embodiments. Technicians in this field explicitly and implicitly understand that the embodiments described in present disclosure can be combined with other embodiments.

The present disclosure provides an antenna system 10 which can be applied to an electronic device 1. The electronic device 1 includes but is not limited to an electronic device with communication function, such as a mobile phone, a mobile internet device (MID), an e-book, a Play Station Portable (PSP), a Personal Digital Assistant (PDA), or the like.

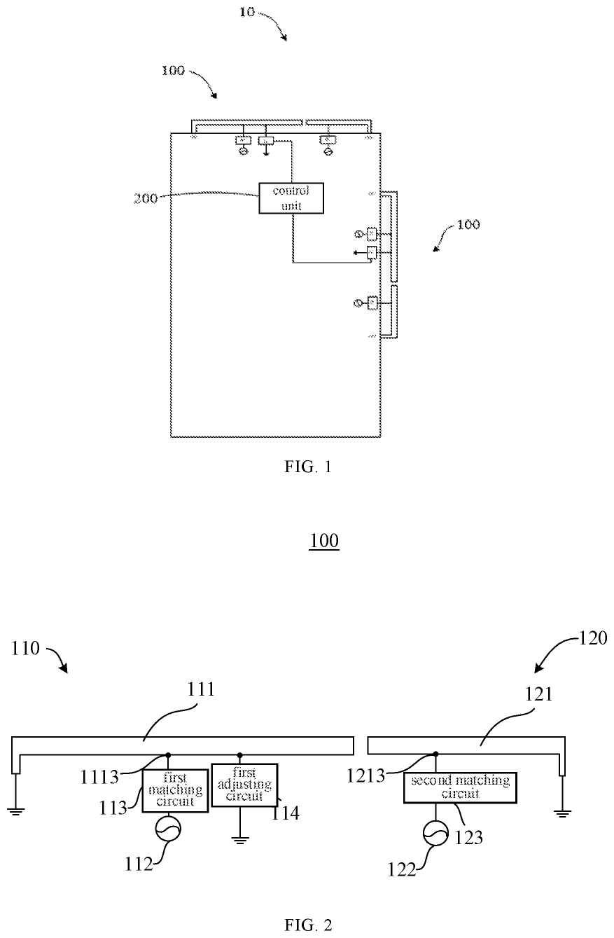

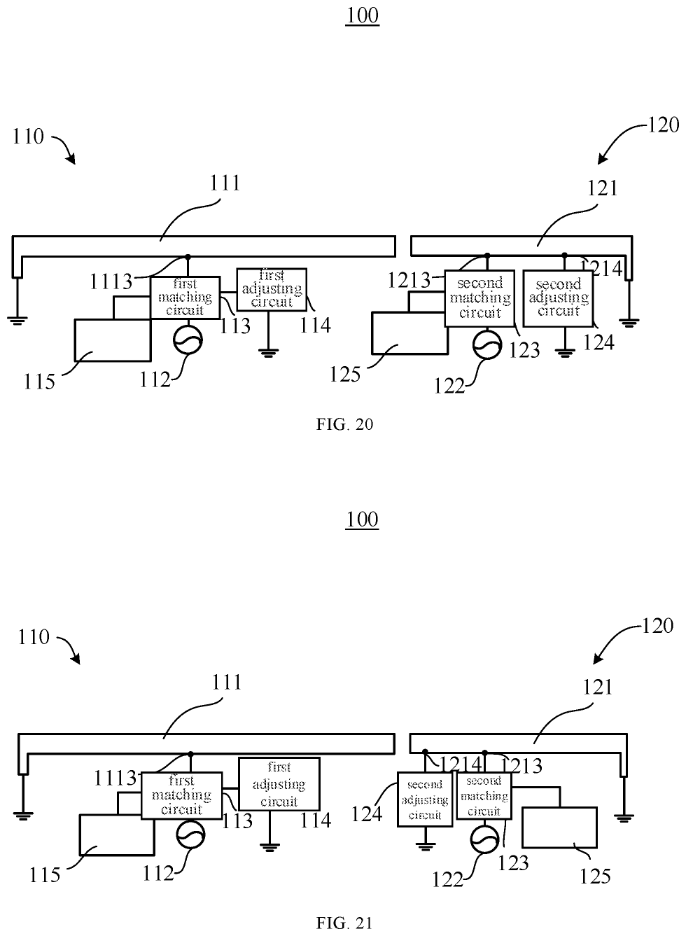

Referring to FIGS. 1 and 2, FIG. 1 is a schematic view of the antenna system in an embodiment, and FIG. 2 is a schematic view of the antenna assembly in the antenna system of FIG. 1. The antenna system 10 includes at least two antenna assemblies 100 and a control unit 200. Each antenna assembly 100 includes a first antenna 110. The first antenna 110 includes a first radiator 111, a first signal source 112, a first matching circuit 113, and a first adjusting circuit 114. The first radiator 111 has a first feed point 1113. The first signal source 112 is electrically connected to the first feed point 1113 through the first matching circuit 113. The first adjusting circuit 114 is electrically connected to the first radiator 111 (see FIG. 2) or the first matching circuit 113 (see FIG. 20), and is configured to adjust the resonant frequency point of the first antenna 110, such that the first antenna 110 supports transceiving of the electromagnetic wave signals in the first frequency band range. The first frequency band range includes at least one of a long term evolution (LTE) low frequency band and a new radio (NR) low frequency band. The control units 200 is configured to control the first antenna 110 of the first antenna assembly 100 to support the LTE low frequency band, and control the other antenna assembly 100 to support the NR low frequency band, so as to implement LTE NR Double Connection (ENDC) of the LTE low frequency band and the NR low frequency band. In FIG. 1, M1 represents the first matching circuit 113 and T1 represents the first adjusting circuit 114.

The terms “first”, “second”, etc. in the specification and claims of present disclosure, as well as the accompanying drawings, are used to distinguish different objects, rather than to describe a specific order. In addition, the terms “comprising”, “including” and “having”, as well as any variations of them, are intended to cover non-exclusive inclusions. The fact that the antenna system 10 includes the first antenna 110 does not exclude the fact that the antenna system 10 also includes other antennas besides the first antenna 110. The signal source refers to the device that generates an excitation signal. When the first antenna 110 is configured to receive an electromagnetic wave signal, the first signal source 112 generates a first excitation signal, and the first excitation signal is loaded onto the first feed point 1113 through the first matching circuit 113, thereby causing the first radiator 111 to radiate the electromagnetic wave signal.

The first radiator 111 may be a flexible printed circuit (FPC) antenna radiator, a laser direct structuring (LDS) antenna radiator, a print direct structuring (PDS) antenna radiator, or a metal branch.

Furthermore, since the first antenna 110 includes the first adjusting circuit 114, the first adjusting circuit 114 can adjust the resonant frequency point of the first antenna 110, such that the first antenna 110 supports transceiving of the electromagnetic wave signals of the first frequency band range. The first frequency band range includes at least one of the LTE low frequency band and the NR low frequency band. “The first frequency band range includes at least one of the LTE low frequency band and the NR low frequency band” includes: the first frequency band range includes the LTE low frequency band; alternatively, the first frequency band includes the LTE low frequency band and the NR low frequency band; alternatively, the first frequency band includes the NR low frequency band. Therefore, the control unit 200 may control the first antenna 110 of one antenna assembly 100 to support the LTE low frequency band, and the first antenna 110 of another antenna assembly 100 supports the NR low frequency band, to implement the ENDC of the LTE low frequency band and the NR low frequency band. That is, the ENDC of the LTE low frequency band and the NR low frequency band can be implemented by the two antenna assemblies 100. Therefore, the antenna system 10 can realize the communication functions of the 4G low frequency band and the 5G low frequency band by using less antenna assemblies 100, and the antenna assemblies 100 are used less while higher communication performance is ensured.

When the two antenna assemblies 100 implement ENDC of the LTE low frequency band and the NR low frequency band, the first antenna 110 of the two antenna assemblies 100 is a wideband antenna (600 MHz-960 MHz). When two antenna assemblies 100 implement ENDC of the LTE low frequency band and the NR low frequency band, the primary receive (PRX) of the LTE low frequency band and the diversity receive (DRX) of the NR low frequency band are supported by the first antenna 110 of one antenna assembly 100, and the diversity receive (DRX) of the LTE low frequency band and the primary receive (PRX) of the NR low frequency band are supported by the first antenna 110 of another antenna assembly 100. The following is an example of how two antenna assemblies 100 can support the B20+N28 frequency band when implementing ENDC of the LTE low frequency band and the NR low frequency band. Specifically, the primary receive (PRX) of B20 and the diversity receive (DRX) of N28 are supported by the first antenna 110 of one antenna assembly 100, while the diversity receive (DRX) of B20 and the primary receive (PRX) of N28 are supported by the first antenna 110 of another antenna assembly 100.

The Lower Band (LB) frequency band and the Non-Standalone (NSA) of the Lower Band frequency band, that is LB+LB NSA, refer to the joint operation of the LB LTE and LB NR, which requires two signal sources (PA) to work simultaneously to transmit signals. Typically, each of LB LTE and NR requires two antennas, i.e., PRX and DRX. Therefore, four antennas are required. However, the antenna size of the low frequency band is too large, making it difficult for mobile phones to make four low frequency band antennas. In present disclosure, the primary receive (PRX) of the LTE low frequency band and the diversity receiver (DRX) of the NR low frequency band are supported by the first antenna 110 of one antenna assembly 100, the diversity reception (DRX) of the LTE low frequency band and the primary receive (PRX) of the NR low frequency band are supported by the first antenna 110 of another antenna assembly 100, and LB+LB NSA can be achieved by using two first antennas 110, thereby reducing the number of first antennas 110.

In an embodiment, each antenna assembly 100 further includes a second antenna 120 including a second radiator 121, a second signal source 122, and a second matching circuit 123. The second radiator 121 and the first radiator 111 are spaced apart from each other and coupled to each other. The second radiator 121 has a second feed point 1213, and the second signal source 122 is electrically connected to the second feed point 1213 through the second matching circuit 123.

In FIG. 1, M2 is illustrated as the second matching circuit 123. When the second antenna 120 is configured to receive the electromagnetic wave signal, the second signal source 122 generates a second excitation signal, and the second excitation signal is loaded onto the second feed point 1213 through the second matching circuit 123, to cause the second radiator 121 to receive and generate the magnetic wave signal.

The second radiator 121 can be an FPC antenna radiator, an LDS antenna radiator, a PDS antenna radiator, or a metal branch. The types of the second radiators 121 and the first radiator 111 can be the same or different.

In other embodiments, the antenna assembly 100 may also not include the second antenna 120.

In the antenna system 10 of the present embodiment, the second radiator 121 and the first radiator 111 are spaced apart from each other and coupled to each other. That is, the first radiator 111 and the second radiator 121 have the same caliber. Due to the coupling action of the first radiator 111 and the second radiator 121, when the first antenna 110 operates, not only the first radiator 111 is utilized to receive and transmit electromagnetic wave signals, electromagnetic wave signals are also transmitted and received by the second radiator 121, thereby enabling the first antenna 110 to operate in a wide frequency band. Similarly, when the second antenna 120 operates, not only can the second radiator 121 be configured to transmit and receive electromagnetic wave signals, but also the first radiator 111 can be configured to transmit and receive electromagnetic wave signals, so that the second antenna 120 can operate in a wider frequency band. In addition, since the first antenna 110 can utilize not only the first radiator 111 but also the second radiator 121 to transmit and receive electromagnetic wave signals during operation, the second antenna 120 can utilize not only the second radiator 121 but also the first radiator 111 during operation. Therefore, the multiplexing of the radiators in the antenna system 10 and the spatial multiplexing are achieved, which is beneficial for reducing the size of the antenna system 10. From the above analysis, it can be seen that the size of the antenna system 10 is small, and when the antenna system 10 is applied to the electronic device 1, it is easy to stack with other devices of the electronic device 1. In addition, due to the small size of the antenna system 10, when the antenna system 10 is applied to the electronic device 1, more antenna systems 10 can be installed in the electronic device 1.

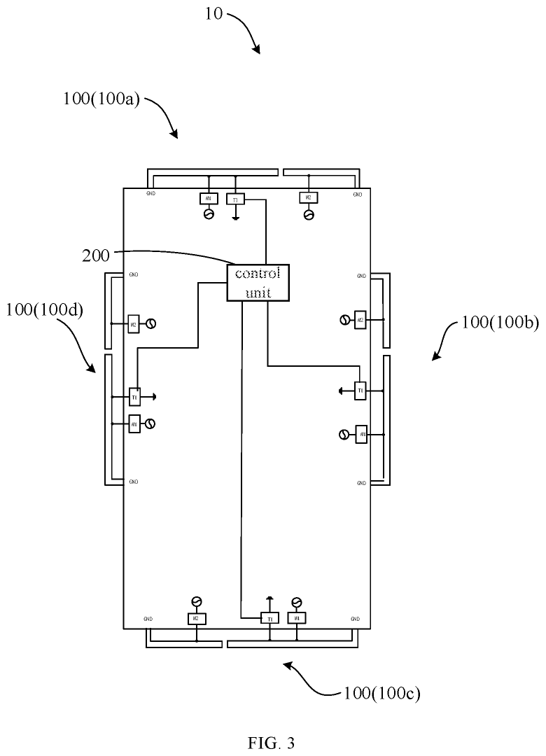

Referring to FIG. 3, FIG. 3 is a schematic view of the antenna system according to another embodiment of the present disclosure. The antenna system 10 includes four antenna assemblies 100. The control unit 200 is also configured to control one of two antenna assemblies 100 in the four antenna assemblies 100 to support the same LTE low frequency band, or control two antenna assemblies 100 in the four antenna assemblies 100 to jointly support the same LTE low frequency band; and control one of the other two antenna assemblies 100 in the four antenna assemblies 100 to support the same NR low frequency band, or control the other two antenna assemblies 100 in the four antenna assemblies 100 to jointly support the same NR low frequency band.

“The control unit 200 is also configured to control one of two antenna assemblies 100 in the four antenna assemblies 100 to support the same LTE low frequency band, or control two antenna assemblies 100 in the four antenna assemblies 100 to jointly support the same LTE low frequency band” includes: the control unit 200 controls one of the two antenna assemblies 100 of the four antenna assemblies 100 to support the LTE low frequency band; alternatively, the control unit 200 is further configured to control two of the four antenna elements 100 to jointly support the same LTE low frequency band.

“The control unit 200 is configured to control one of the other two antenna assemblies 100 in the four antenna assemblies 100 to support the same NR low frequency band, or control the other two antenna assemblies 100 in the four antenna assemblies 100 to jointly support the same NR low frequency band” includes: the control unit 200 controls one of the two antenna assemblies 100 of the four antenna assemblies 100 to support the NR low frequency band; alternatively, the control unit 200 is further configured to control two of the four antenna assemblies 100 to jointly support the same NR low frequency band.

The control unit 200 is configured to adjust the first adjusting circuit 114 of at least one first antenna 110 in the two antenna assemblies 100, thereby adjusting the LTE low frequency band commonly supported by the two antenna assemblies 100. The control unit 200 is further configured to adjust the first adjusting circuit 114 of at least one first antenna 110 in the other two antenna assemblies 100, thereby adjusting the NR low frequency band commonly supported by the other two antenna assemblies 100, such that the antenna system 10 supports the first ENDC combination, the second ENDC combination, and the third ENDC combination. The control unit 200 is also configured to control the antenna system 10 to switch between the first ENDC combination, the second ENDC combination, and the third ENDC combination.

In an embodiment, the first ENDC combination includes B20+N28, the second ENDC combination includes B20+N8, and the third ENDC combination includes B28+N5.

For ease of description, four antenna assemblies 100 are named as an antenna assembly 100a, an antenna assembly 100b, an antenna assembly 100c, and an antenna assembly 100d. The first antenna 110 of the antenna assembly 100a supports a first frequency band (a), the first antenna 110 of the antenna assembly 100b supports a first frequency band (b), the first antenna 110 of the antenna assembly 100c supports a first frequency band (c), and the first antenna 110 of the antenna assembly 100d supports a first frequency band (d). A combined bandwidth formed by the first frequency band (a), the first frequency band (b), the first frequency band (c), and the first frequency band (d) is greater than or equal to 350 MHz. Optionally, each of the first frequency band (a), the first frequency band (b), the first frequency band (c) and the first frequency band (d) supports a bandwidth of 80 M to 100 M. The control unit 200 adjusts the first frequency band (a), the first frequency band (b), the first frequency band (c) and the first frequency band (d) to have no coincidence or less coincidence, such that during the same time period, the sum of the bandwidths of the first frequency band (a), the first frequency band (b), the first frequency band (c) and the first frequency band (d) is greater than or equal to 350 MHz, thereby simultaneously supporting the low frequency signals with a bandwidth of at least 350 MHz. In other embodiments, the control unit 200 adjusts the first adjusting circuit 114, so that the resonant frequency point of the electromagnetic wave signal transmitted and received by the first antenna 110 of each antenna assembly 100 is offset, thereby enabling the bandwidth of the electromagnetic wave signal transmitted and received by each antenna assembly 100 within different time periods to be larger than or equal to 350 MHz.

In an embodiment, the combined frequency band formed by the first frequency band (a), the first frequency band (b), the first frequency band (c) and the first frequency band (d) covers 617 MHz to 960 MHz. The antenna system 10 provided by the embodiment of the present disclosure is provided with each first antenna 110 of four antenna assemblies 100, so that the combined bandwidth formed by the first frequency band (a), the first frequency band (b), the first frequency band (c) and the first frequency band (d) is greater than or equal to 350 MHz. Therefore, the antenna system 10 can cover the application frequency band 617 MHz to 960 MHz, the electronic device 1 can cover the combined frequency band 617 MHz to 960 MHz, and the communication performance of the electronic device 1 in the low frequency band is improved.

The combined frequency band formed by the first frequency band (a), the first frequency band (b), the first frequency band (c) and the first frequency band (d) covers the first application frequency band and the second application frequency band. The first application frequency band includes a 4G frequency band, and the second application frequency band includes a 5G frequency band. For example, the first application frequency band includes at least one of B20 and B28. The second application frequency band includes at least one of N28, N8, and N5. Accordingly, the electronic device 1 can support both 4G communication and 5G communication, enabling ultra-wideband carrier aggregation (CA) and the LTE NR Double connection (ENDC) of 4G wireless access network and 5G-NR.

Because the antenna system 10 has a wide bandwidth, for example, greater than 350 MHz. The antenna system 10 may support B20+N28 frequency bands. In addition, the antenna system 10 also supports B28+N5 frequency bands, B20+N8 frequency bands and the like, so that the electronic device 1 can support the frequency band range planned by each operator, and the applicability of the electronic device 1 to different planned frequency bands is improved.

In a possible embodiment, the first antenna 110 of at least two of the antenna assemblies 100a, 100b, 100c and 100d is configured to support the first application frequency band or the second application frequency band. The frequency bands range transmitted and received by the first antenna 110 of the at least two antenna assemblies 100 supporting the first application frequency band or the second application frequency band partially overlaps or does not overlap within the same time period.

Specifically, when the bandwidth of the first application frequency band is relatively large or in order to improve the transmit-receive efficiency of the first application frequency band, two, three, or four of the antenna assembly 100a, the antenna assembly 100b, the antenna assembly 100c, and the antenna assembly 100d are controlled to support the first application frequency band; and the antenna assembly 100a, the antenna assembly 100b, the antenna assembly 100c, and the antenna assembly 100d are controlled to support the second application frequency band.

Further, each of the first frequency band (a), the first frequency band (b), the first frequency band (c) and the first frequency band (d) supports a bandwidth of 80 M to 100 M. By adjusting and controlling the first frequency band (a), the first frequency band (b), the first frequency band (c) and the first frequency band (d), there is no or less pairwise coincidence in the same time period. As such, the first antenna 110 of the two antenna assemblies 100 may support the first application frequency band, the first antenna 110 of the other two antenna assemblies 100 may support the second application frequency band. Thus the first application frequency band and the second application frequency band may be supported simultaneously, and the two application frequency bands may be supported by different antenna assemblies 100, to reduce the mutual influence between the first application frequency band and the second application frequency band.

When the electronic device 1 needs to operate in the first application frequency band, the shielding condition of the antenna system 10 can be judged according to the condition that the electronic device 1 is held, and two antenna elements 100 supporting the first application frequency band are flexibly selected according to the shielding condition of the antenna system 10. For example, when the antenna assembly 100a and the antenna assembly 100c of the antenna assembly 100a, the antenna assembly 100b, the antenna assembly 100c, and the antenna assembly 100d are shielded, the control unit 200 selects the antenna assembly 100b and the antenna assembly 100d to support the first application frequency band. Thus, the control unit 200 may control the frequency bands supported by each of the antenna assemblies 100a, 100b, 100c, and 100d, thereby effectively solving the problem of relatively weak signals caused by the holding scene of the electronic device 1. When the head of the human body is close to the electronic device 1, the control unit 200 can also control the antenna assembly 100 that is farther away from the head of the human body to operate, or reduce the power of the antenna assembly 100, in order to improve the safety of the electronic device 1.

When the antenna system 10 supports ENDC combination, the control unit 200 controls any two of the antenna assemblies 100a, 100b, 100c, and 100d to support the LTE frequency band, and controls the other two antenna assemblies to support the NR frequency band, thereby implementing ENDC. The first ENDC combination, including B20+N28, will be introduced as an example below. The antenna system 10 may support the ENDC combination of B20+N28 frequency bands. The control unit 200 controls any two of the antenna assemblies 100a, 100b, 100c, and 100d to support the B20 frequency band, and control the other two antenna elements to support the N28 frequency band. For example, in an embodiment, the control unit 200 controls the antenna assembly 100a and the antenna assembly 100c to jointly support the B20 frequency band, and controls the antenna assembly 100b and the antenna assembly 100d to jointly support the N28 frequency band. In other embodiments, the control unit 200 controls the antenna assembly 100b and the antenna assembly 100c to jointly support the N28 frequency band, and controls the antenna assembly 100a and the antenna assembly 100d to jointly support the N28 band. The control unit 200 may select two of the four antenna assemblies to jointly support the LTE frequency band, and select the other two antenna assemblies to jointly support the NR frequency band according to the specific usage of the electronic device 1 (e.g., the scene being held), and the foregoing examples should not be construed as limiting the present disclosure.

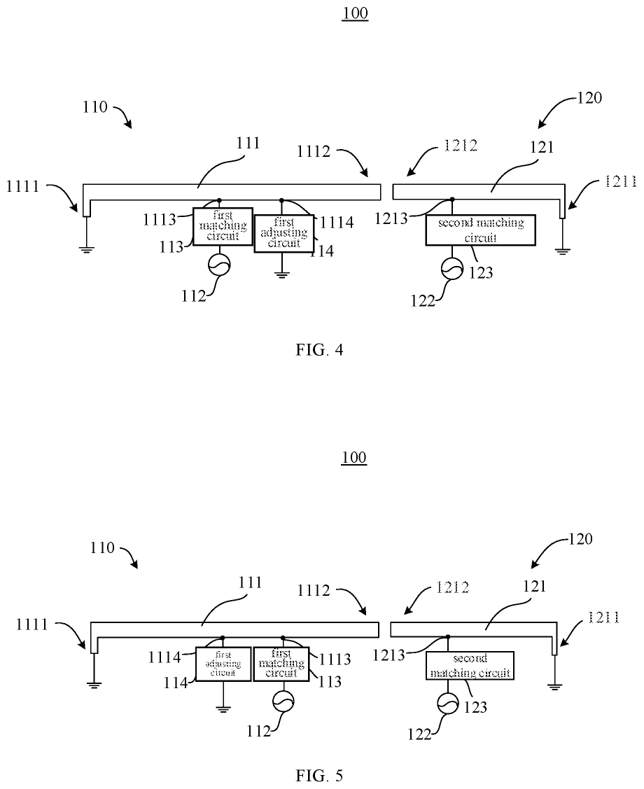

Referring to FIG. 4, FIG. 4 is a schematic view of the antenna assembly according to another embodiment of the present disclosure. The first radiator 111 has a first free end 1112 and a first grounding end 1111 opposite to the first free end 1112, and the first grounding end 1111 is grounded. The first radiator 111 further includes a first connection point 1114, the first feed point 1113 and the first connection point 1114 are spaced apart from each other between the first free end 1112 and the first grounding end 1111. When the first adjusting circuit 114 is electrically connected to the first radiator 111, the first adjusting circuit 114 is electrically connected to the first connection point 1114. In an embodiment, the first connection point 1114 is located between the first free end 1112 and the first feed point 1113.

The second radiator 121 further includes a second grounding end 1211 and a second free end 1212. The second grounding end 1211 is grounded. The second free end 1212 is spaced apart from the first radiator 111 (in an embodiment, the second free end 1212 is spaced apart from the first free end 1112), and the second feed point 1213 is located between the second grounding end 1211 and the second free end 1212.

Referring to FIG. 5, FIG. 5 is a schematic view of the antenna assembly according to another embodiment of the present disclosure. The first radiator 111 has the first free end 1112 and the first grounding end 1111 opposite to the first free end 1112. The first grounding end 1111 is grounded. The first radiator 111 further includes a first connection point 1114. The first feed point 1113 and the first connection point 1114 are spaced apart from each between the first free end 1112 and first grounding end 1111. When the first adjusting circuit 114 is electrically connected to the first radiator 111, the first adjusting circuit 114 is electrically connected to the first connection point 1114. In an embodiment, the first connection point 1114 is located between the first grounding end 1111 and the first feed point 1113.

When the first connection point 1114 is located between the first free end 1112 and the first feed point 1113, the impact of the electromagnetic wave signal supported by the first radiator 111 (corresponding to the electromagnetic wave signal supported by the second resonant mode later) on the electromagnetic wave signals of other frequency bands supported by the antenna assembly 100 can be reduced. The first connection point 1114 may also be located between the first grounding end 1111 and the first feed point 1113, as long as the first adjusting circuit 114 is electrically connected to the first connection point 1114 so that the first antenna 110 can transmit and receive electromagnetic wave signals within the first frequency band range. In addition, the position of the first connection point 1114 on the first radiator 111 is also related to the range of transceiving of electromagnetic wave signals supported by the first antenna 110.

In an embodiment, the antenna assembly 100 has the first resonance mode, the second resonance mode, the third resonance mode, and the fourth resonance mode, to cover transceiving of electromagnetic wave signals in the second frequency band range and the third frequency band range.

At least one of the first resonance mode, the second resonance mode, the third resonance mode, and the fourth resonance mode is generated by the high-order modes of the first adjusting circuit 114 and the first radiator 111 from the first connection point 1114 to the first free end 1112.

Specifically, when one end of the first adjusting circuit 114 is grounded, and the other end is connected to the first connection point 1114, the fundamental mode from the second grounding end 1211 of the second radiator 121 to the second free end 1213 generates the first resonance mode. The fundamental mode from the first connection 1114 of the first adjusting circuit 114 and the first radiator 111 to the first free end 1112 generates the second resonance mode, the fundamental mode from the second feed point 1213 of the second radiator 121 to the second free end 1212 generates the third resonance mode, and the high order mode from the first connection point 1114 of the first adjusting circuit 114 and the first radiator 111 to the first free end 1112 generates the fourth resonance mode.

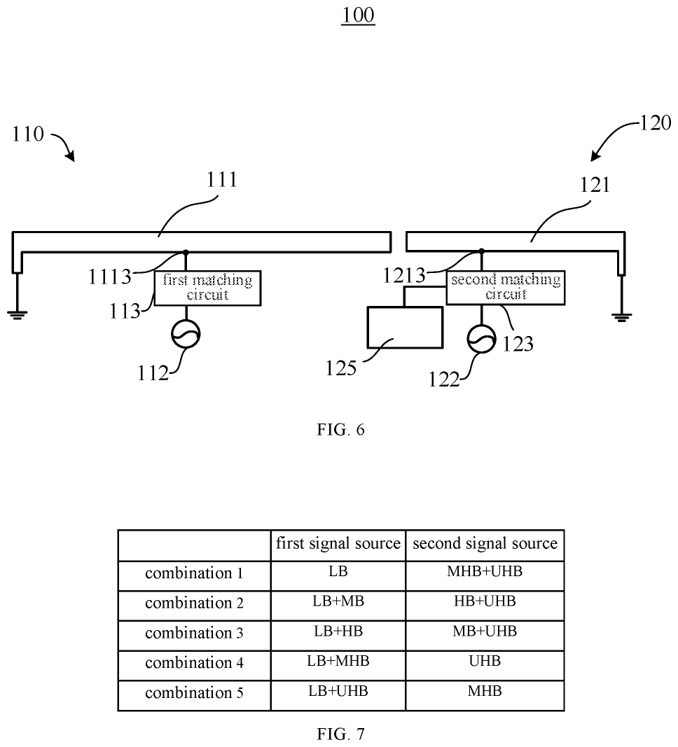

Referring to FIG. 6, FIG. 6 is a schematic view of the antenna assembly according to an embodiment of the present disclosure. The antenna assembly 100 includes the first antenna 110 and the second antenna 120. The first antenna 110 includes a first radiator 111, a first signal source 112, and a first matching circuit 113. The first radiator 111 has a first feed point 1113, and the first signal source 112 is electrically connected to the first feed point 1113 through the first matching circuit 113. The second antenna 120 includes a second radiator 121, a third radiator 125, a second signal source 122, and a second matching circuit 123. The second radiator 121 and the first radiator 111 are spaced apart from each other and coupled to each other. The second radiator 121 has a second feed point 1213, and the second signal source 122 is electrically connected to the second feed point 1213 through the second matching circuit 123. The second signal source 122 is further electrically connected to the third radiator 125 through the second matching circuit 123. The first antenna 110 and the second antenna 120 cooperate to transmit and receive electromagnetic wave signals of at least one of the first frequency band range, the second frequency band range and the third frequency band range.

In addition, the second radiator 121 and the third radiator 125 of the second antenna 120 in the antenna assembly 100 share the second matching circuit 123. Thus, when the second antenna 120 receives and transmits electromagnetic wave signals, not only can the second radiator 121 be used for receiving and transmitting the electromagnetic wave signals, but also the third radiator 125 can be used for receiving and transmitting the electromagnetic wave signals, so that the second antenna 120 can support the receiving and transmitting of the electromagnetic wave signals in multiple frequency bands.

In an embodiment, the first antenna 110 is configured to transmit and receive electromagnetic wave signals in the first frequency band range, and the second antenna 120 is configured to transmit and receive electromagnetic wave signals in the second frequency band range and the third frequency band range. The first frequency band range includes a Lower Band (LB) frequency band, the second frequency band range includes a Middle High Band (MHB) frequency band, and the third frequency band range includes an Ultra High Band (UHB) frequency band.

The LB frequency band refers to a frequency band with a frequency lower than 1000 MHz. The range of MHB frequency band is 1000 MHz to 3000 MHz. The range of the UHB frequency band is 3000 MHz to 6000 MHz. The application frequency band included in the MHB frequency band includes B3, B1, B41 and B7. The application frequency band included in the UHB frequency band includes N77, N78 and N79, so that the electronic device 1 can support the frequency band range planned by each operator, and the applicability of the electronic device 1 to different planned frequency bands is improved.

In other embodiment, the first antenna 110 and the second antenna 120 also support transceiving of electromagnetic wave signals in other frequency band ranges. The situation where the first antenna 110 and the second antenna 120 in other embodiments support electromagnetic wave signals in other frequency bands will be described in detail later as follows.

Referring to FIG. 6 and FIG. 7, FIG. 7 is a table of transceiving of electromagnetic wave signals supported by the antenna assembly according to an embodiment of the present disclosure. In this table, combination 1 indicates that the first antenna 110 is configured to transmit and receive electromagnetic wave signals in the first frequency range, and the second antenna 120 is configured to transmit and receive electromagnetic wave signals in the second frequency range and the third frequency range. The combination 2 indicates that the first antenna 110 is configured to transmit and receive electromagnetic wave signals in the first frequency band range and the second frequency band range, the second antenna 120 is configured to transmit and receive electromagnetic wave signals in the third frequency band range and the fourth frequency band range. The first frequency band range includes the LB frequency band range, the second frequency band includes the MB frequency band, the third frequency band includes the UHB frequency band, the fourth frequency band includes the HB band. The combination 3 indicates that the first antenna 110 is configured to transmit and receive electromagnetic wave signals in the first frequency band range and the fourth frequency band range, the second antenna 120 is configured to transmit and receive electromagnetic wave signals in the second frequency band range and the fourth frequency band range. The combination 4 indicates that the first antenna 110 is configured to transmit and receive electromagnetic wave signals in the first frequency band range and the second frequency band range, the second antenna 120 is configured to transmit and receive electromagnetic wave signals in the third frequency band range. The combination 5 indicates that the first antenna 110 is configured to transmit and receive electromagnetic wave signals in the first frequency band range and the third frequency band range, the second antenna 120 is configured to transmit and receive electromagnetic wave signals in the second frequency band range. In the combination 1 to combination 5 described above, the first frequency band range includes the LB frequency band, the second frequency band range includes the MB frequency band, the third frequency band range includes the UHB frequency band, and the fourth frequency band range includes the HB frequency band.

In the next embodiment, taking the first antenna 110 as an example for transmitting and receiving electromagnetic wave signals in the first frequency band range, and the second antenna 120 as an example for transmitting and receiving electromagnetic wave signals in the second frequency band range and the third frequency band range.

In an embodiment, the antenna assembly 100 has the first resonance mode, the second resonance mode, the third resonance mode, and the fourth resonance mode, to cover transceiving of electromagnetic wave signals in the second frequency band range and the third frequency band range.

At least one of the first resonance mode, the second resonance mode, the third resonance mode, and the fourth resonance mode is generated by the third radiator. Each resonance mode is later described in conjunction with a simulated schematic view of the antenna assembly 100.

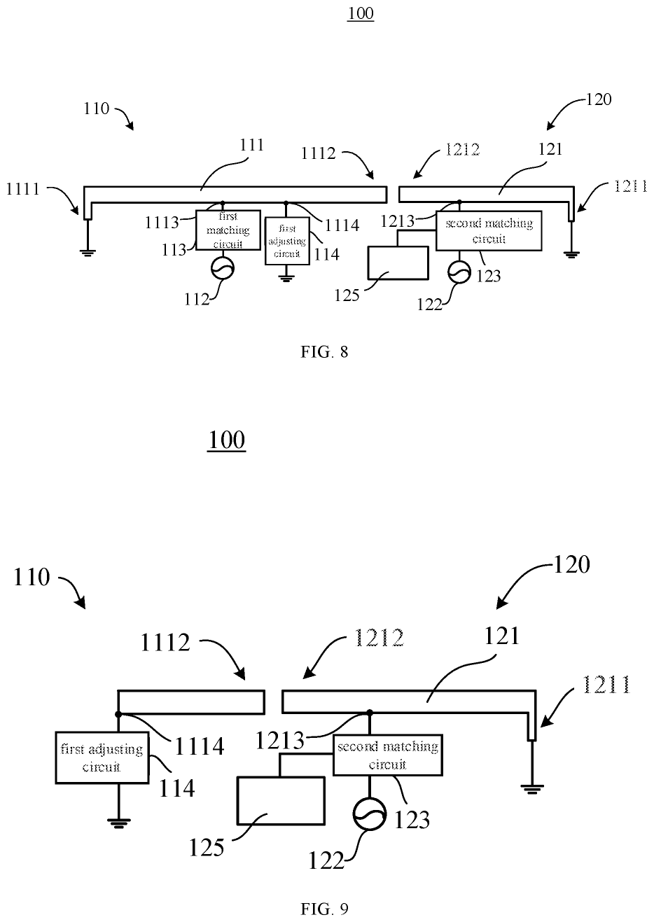

Referring to FIG. 6, FIG. 8 and FIG. 9, FIG. 8 is a schematic view of the antenna assembly according to another embodiment of the present disclosure. FIG. 9 is an equivalent schematic view that the first adjusting circuit in FIG. 8 implements the low impedance of the second frequency band range and the third frequency band range to ground. The first antenna 110 further includes a first adjusting circuit 114, and the first adjusting circuit 114 is configured to achieve low impedance of electromagnetic wave signals in the second and third frequency bands to the ground.

The first adjusting circuit 114 realizes low impedance of electromagnetic wave signals in the second frequency band range and the third frequency band range to the ground. A radiator of the first radiator 111 between the connection point of the first adjusting circuit 114 connected to the first radiator 111 and the grounding end (first grounding end 1111) is equivalent to zero. The equivalent antenna assembly 100 is shown in FIG. 9, which will be introduced later in conjunction with the simulation diagram of the S parameter.

In an embodiment, the first radiator 111 further has a first grounding end 1111, a first free end 1112 and a first connection point 1114. The first grounding end 1111 is grounded. The first connection point 1114 and the first feed point 1113 are spaced apart from each other and are both arranged between the first free end 1112 and the first grounding end 1111. One end of the first adjusting circuit 114 is grounded, and the other end is electrically connected to the first connection point 1114. The second radiator 121 further includes a second grounding end 1211 and a second free end 1212. The second grounding end 1211 is grounded, and the second free end 1212 and the first free end 1112 are spaced apart from each other. The second feed point 1213 is located between the second grounding end 1211 and the second free end 1212.

In an embodiment, the first connection point 1114 is disposed between the first feed point 1113 and the first free end 1112.

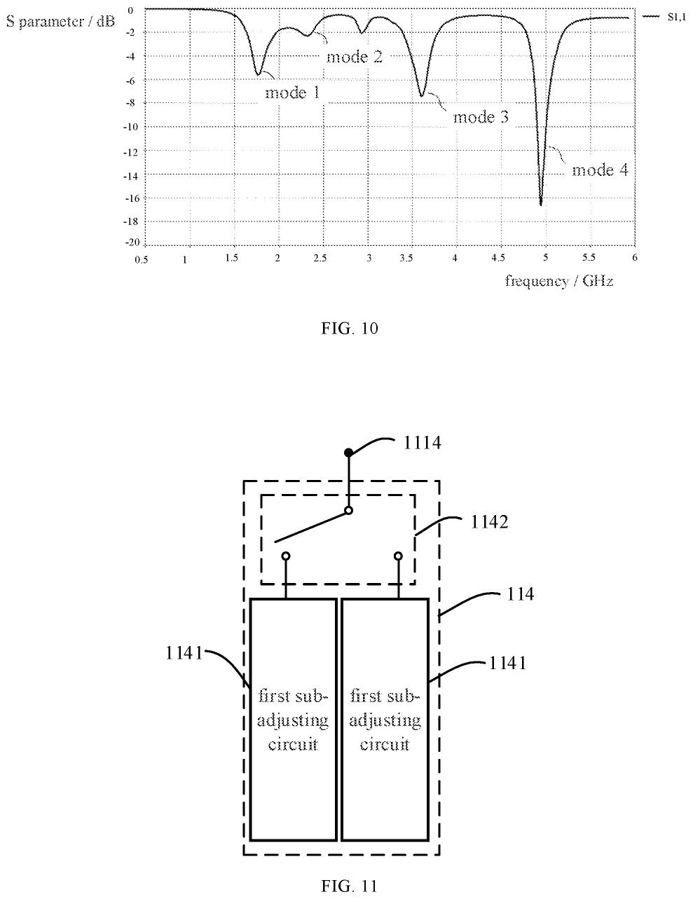

Referring to FIG. 10, FIG. 10 is a schematic illustration of a simulation of some S parameters of the antenna assembly of FIG. 6. In a schematic illustration of the present embodiment, the horizontal axis represents the frequency in GHz, and the vertical axis represents the S parameter in dB. The second grounding end 1211 to the second free end 1212 of the second radiator 121 generates the first resonance mode (designated mode 1). The second resonance mode (designated mode 2) is generated from the first connection point 1114 of the first adjusting circuit 114 and the first radiator 111 to the first free end 1112. The third resonance mode (designated mode 3) is generated by the second feed point 1213 of the second radiator 121 to the second free end 1212. The third radiator 125 produces the fourth resonance mode (designated mode 4).

According to the simulation diagram of the embodiment, the first resonance mode, the second resonance mode, the third resonance mode and the fourth resonance mode in the antenna assembly 100 can cover the receiving and transmitting of electromagnetic wave signals of the MHB frequency band and the UHB frequency band. That is, the receiving and transmitting of the electromagnetic wave signals of the 1000 MHz to 6000 MHz frequency band are realized.

In an embodiment, the first resonance mode is the fundamental mode or the high order mode that the second antenna 120 operates from the second grounding end 1211 of the second radiator 121 to the second free end 1212. The second resonance mode is the fundamental mode or the high order mode that the first antenna 110 operates from the first connection point 1114 of the first adjusting circuit 114 and the first radiator 111 to the first free end 1112. The third resonance mode is the fundamental mode or the high order mode that the second antenna 120 operates from the second feed point 1213 of the second radiator 121 to the second free end 1212. The fourth resonance mode is the fundamental mode or the high order mode that the second antenna 120 operates in the third radiator 125.

In this embodiment, the first resonance mode is the fundamental mode that the second antenna 120 operates from the second grounding end 1211 of the second radiator 121 to the second free end 1212. The second resonance mode is the fundamental mode that the first antenna 110 operates from the first connection point 1114 of the first adjusting circuit 114 and the first radiator 111 to the first free end 1112. The third resonance mode is the fundamental mode that the second antenna 120 operates from the second feed point 1213 of the second radiator 121 to the second free end 1212. The fourth resonance mode is the fundamental mode that the second antenna 120 operates in the third radiator 125.

The first resonance mode is a quarter wavelength fundamental mode that the second antenna 120 operates from the second grounding end 1211 of the second radiator 121 to the second free end 1212. When the first resonance mode is the fundamental mode in which the second antenna 120 operates from the second grounding end 1211 of the second radiator 121 to the second free end 1212, the first resonance mode has a higher transmit-receive power.

When the second resonance mode is the fundamental mode that the first antenna 110 operates from the first connection point 1114 of the first adjusting circuit 114 and the first radiator 111 to the first free end 1112, the second resonance mode has a higher transmit-receive power. When the third resonance mode is the fundamental mode that the second antenna 120 operates from the second feed point 1213 of the second radiator 121 to the second free end 1212, the third resonance mode has a higher transmit-receive power. When the fourth resonance mode is the fundamental mode that the second antenna 120 operates in the third radiator 125, the fourth resonance mode has a higher transmit-receive power.

Referring to FIG. 11, FIG. 11 is a schematic view of the first adjusting circuit according to an embodiment of the present disclosure. The first adjusting circuit 114 includes a plurality of sub-adjusting circuits and a switching unit. For ease of description, the sub-adjusting circuits included in the first adjusting circuit 114 is named the first sub-adjusting circuit 1141. The switching unit in the first adjusting circuit 114 is named the first switching unit 1142. The first switching unit 1142 is electrically connected to the first connection point 1114, and the first switching unit 1142 also electrically connects the plurality of first sub-adjusting circuits 1141 to ground. The first switching unit 1142 electrically connects at least one of the first sub-adjusting circuits 1141 to the first connection point 1114 under the control of a control signal.

In the schematic view of the embodiment, taking two first sub-adjusting circuits 1141 as examples. The first switching unit 1142 is a single-pole double-throw switch, which is taken as an example. The movable end of the first switching unit 1142 is electrically connected to the first connection point 1114. A fixed end of the first switching unit 1142 is electrically connected to one of the first sub-adjusting circuits 1141 to ground. In other embodiments, the first adjusting circuit 114 includes N first sub-adjusting circuits 1141, the first switching unit 1142 is a single-pole N-throw switch, or the first switching unit 1142 is an N-pole N-throw switch.

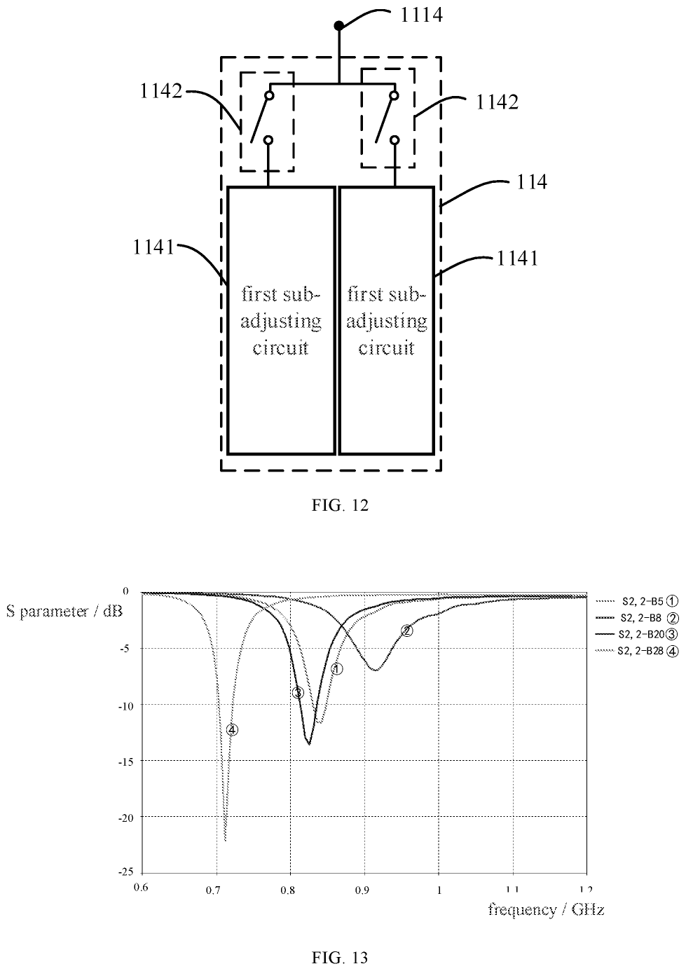

Referring to FIG. 12, FIG. 12 is a schematic view of the first adjusting circuit according to another embodiment of the present disclosure. In an embodiment, the first adjusting circuit 114 includes M first sub-adjusting circuits 1141 and M first switching units 1142, each first switching unit 1142 is connected in series with one first sub-adjusting circuit 1141.

The forms of the first sub-adjusting circuit 1141 of the first adjusting circuit 114 and the first switching unit 1142 are not limited to the several described above, as long as the first switching unit 1142 electrically connects at least one of the multiple first adjusting circuits 1141 to the first connection point 1114 under the control of the control signal.

The first sub-adjusting circuit 1141 includes at least one or more of a capacitance, inductance, and resistance. Thus, the first sub-adjusting circuit 1141 is also referred to as a lumped circuit.

Referring to FIG. 13, FIG. 13 is a simulation diagram of the first adjusting circuit for switching the frequency band supported by the first antenna in the first frequency band range. In the schematic illustration of the present embodiment, the horizontal axis represents the frequency in GHz, and the vertical axis represents the S parameter in dB. In the simulation diagram, curve \textcircled{1} is B5 frequency band, curve \textcircled{2} is B8 frequency band, curve \textcircled{3} is B20 frequency band, and curve \textcircled{4} is the B28 band. The first adjusting circuit 114 is further configured to switch the frequency band supported by the first antenna 110 within the first frequency band range. Specifically, the first adjusting circuit 114 is configured to adjust the resonant frequency band of the first antenna 110, to adjust the frequency band supported by the first antenna 110, thereby achieving switching of the frequency band supported by the first antenna 110 within the first frequency band range. The frequency band supported by the first frequency band range includes a B28 frequency band, a B20 frequency band, a B5 frequency band and a B8 frequency band. The first adjusting circuit 114 is configured to operate the first antenna 110 in any one of a B28 band, a B20 band, a B5 band, and a B8 band and to be switchable among the B28 band, the B20 band, the B5 band, and the B8 band.

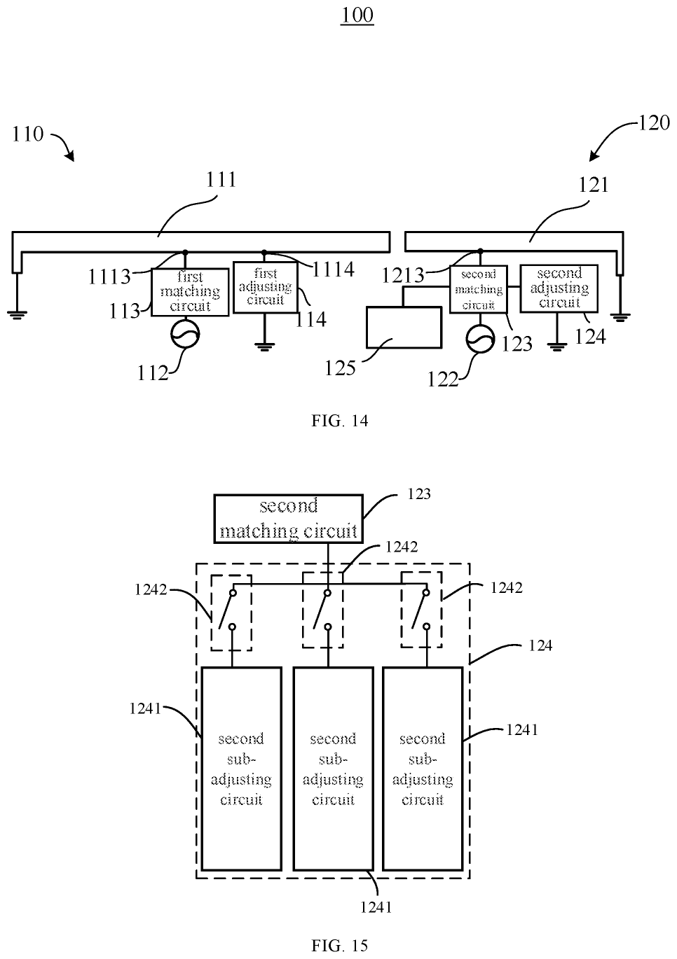

FIG. 14 is a schematic view of the antenna assembly according to another embodiment of the present disclosure. The second antenna 120 further includes a second adjusting circuit 124 for switching the frequency bands supported by the second antenna 120 within the second frequency band range and the third frequency band range.

The second antenna 120 also includes the second adjusting circuit 124 that may be incorporated into the antenna assembly 100 provided in any of the foregoing embodiments. Taking the schematic view of combining the second antenna 120 with the second adjustment circuit 124 into an embodiment as an example for explanation.

In the present embodiment, one end of the second adjusting circuit 124 is grounded, and the other end is electrically connected to the second matching circuit 123.

Referring to FIG. 15, FIG. 15 is a schematic view of the second adjusting circuit according to an embodiment of the present disclosure. The second adjusting circuit 124 includes a plurality of sub-adjusting circuits and a switching unit. For ease of description, the sub-adjusting circuitry included in the second adjusting circuitry 124 is named as the second sub-adjusting circuit 1241, and the switching unit included in the second adjusting circuit 124 is named as the second switching unit 1242. The second switching unit 1242 is configured to electrically connect at least one of the multiple second sub-adjusting circuits 1241 of the second adjusting circuit 124 to the second matching circuit 123 under the control of the control signal. In the schematic view of this embodiment, taking three switches and three second sub-adjusting circuits 1241 of the second adjusting circuit 124 as examples, it is shown that each switch is electrically connected to one second sub-adjusting circuit 1241.

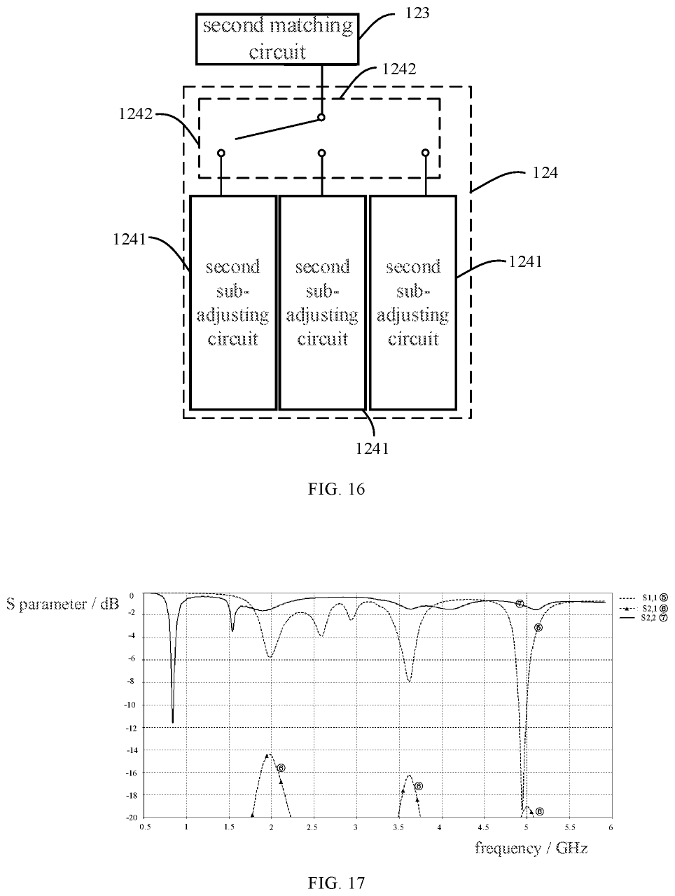

Referring to FIG. 16, FIG. 16 is a schematic view of the second adjusting circuit according to an embodiment of the present disclosure. The second adjusting circuit 124 includes one single-pole triple-throw switch and three second sub-adjusting circuits 1241. The movable end of the single-pole triple-throw switch is electrically connected to the second matching circuit 123, the three fixed ends of the single-pole three-throw switch are electrically connected to three second sub-adjusting circuits 1241, respectively. In other embodiments, the second adjusting circuit 124 includes K second sub-adjusting circuits 1241, the second switching unit 1242 is a single-pole K-throw switch, or the second switching unit 1242 is a K-pole K-throw switch, wherein K is a positive integer greater than or equal to 2.

The second sub-adjusting circuit 1241 includes a combination of at least one or more of capacitance, inductance, and resistance. Thus, the second sub-adjusting circuit 1241 is also referred to as a lumped circuit. The second sub-adjusting circuit 1241 of the first adjusting circuit 114 may be the same as or different from the second sub-adjusting circuit 1241 of the second adjusting circuit 124.

Referring to FIG. 17, FIG. 17 is a schematic simulation diagram of the antenna assembly of FIG. 14. In the schematic illustration of the present embodiment, the horizontal axis represents the frequency in GHz, and the vertical axis represents the S parameter in dB. In this simulation diagram, curve \textcircled{5} represents S1,1 parameter, curve \textcircled{6} represents S2,1 parameter, curve \textcircled{7} represents S2,2 parameter. It can be seen from the simulation diagram, the resonance frequency band of the curve (5) is the LB frequency band, the resonance frequency band of the curve (7) is the MHB frequency band and the UHB frequency band. From curve \textcircled{6}, it can be seen that the LB frequency band has a high degree of isolation from the MHB and UHB frequency bands, respectively. In the antenna assembly 100 of present disclosure, the first antenna 110 and the second antenna 120 are jointly used for realizing LTE NR double connection (ENDC) and carrier aggregation (CA) in the frequency band range of 1000 MHz to 6000 MHz.

The first antenna 110 and the second antenna 120 in the antenna assembly 100 are jointly used for realizing LTE NR Double connection (ENDC) of the 4G wireless access network and the 5G-NR in the frequency band of 1000 MHz to 6000 MHz. Therefore, the antenna assembly 100 provided by the embodiment of the present disclosure can realize ENDC, and simultaneously support a 4G wireless access network and a 5G-NR. Therefore, the antenna assembly 100 provided by the embodiment of the present disclosure can improve the transmission bandwidths of 4G and 5G, and the uplink and downlink molding rate, and has a better communication effect.

The antenna system 10 includes four antenna assemblies 100, the control unit 200 is used for controlling the four antenna assemblies 100 to form carrier aggregation CA of MHB frequency band and MHB frequency band, or 4*4 multiple input multiple output (MIMO) of ENDC of MHB frequency band and UHB frequency band.

The control unit 200 is further configured to control the four antenna elements 100 to form the CA of the MHB band and the UHB band. That is, the control unit 200 is also configured to control the four antenna assemblies 100 to form the in-band CA of the MHB frequency band, in-band CA of the UHB frequency band, and the ENDC in the MHB frequency band and the UHB frequency band.

In this embodiment, the first radiator 111 of the first antenna 110 and the second radiator 121 of the second antenna 120 in the antenna assembly 100 are spaced apart from each other and coupled to each other, and the resonant frequency point of the first antenna 110 is adjusted using the first adjusting circuit 114 in each antenna assembly 100. Thus, only four antenna assemblies 100 are needed to realize carrier aggregation CA of MHB frequency band and MHB frequency band, or 4*4 MIMO of ENDC of MHB frequency band and UHB frequency band, so that the number of the required antenna assemblies 100 is small. In addition, the four antenna assemblies 100 in the antenna system 10 form 4*4 MIMO, so that the antenna system 10 has higher transmission rate.

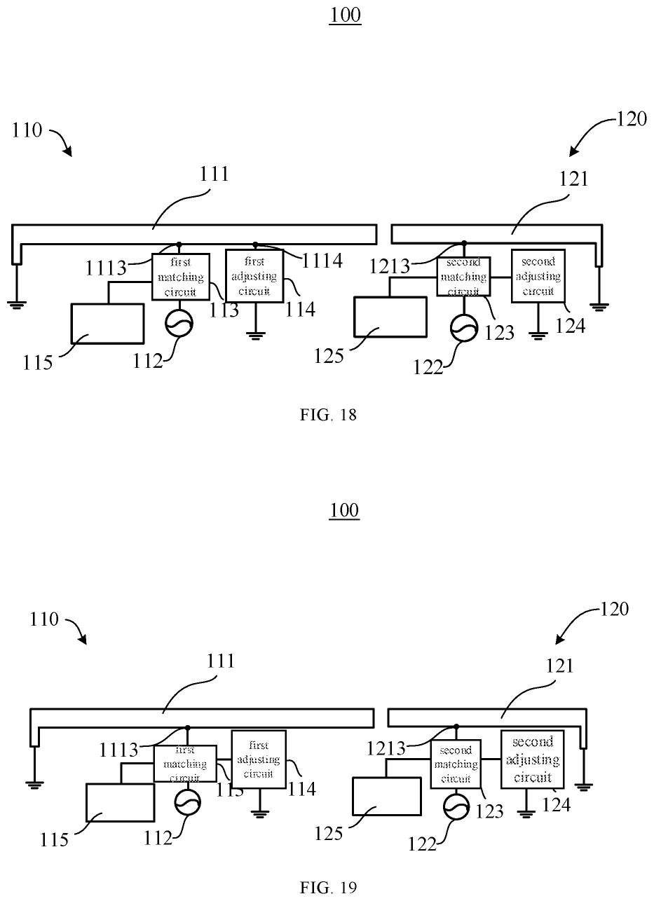

Referring to FIG. 18, FIG. 18 is a schematic view of an antenna assembly according to yet another embodiment of the present disclosure. the first antenna 110 also includes a fourth radiator 115, which is electrically connected to the first matching circuit 113. The fourth radiator 115 is configured to generate at least one resonant mode to expand the bandwidth of the antenna assembly 100.

In this embodiment, taking the first antenna 110, including the fourth radiator 115, as an example, combined with the antenna assembly 100 shown in the schematic view of the previous embodiment for illustration.

Referring to FIG. 19, FIG. 19 is a schematic view of the antenna assembly according to another embodiment of the present disclosure. The structure of the antenna assembly 100 provided in this embodiment is basically the same as that of the antenna assembly 100 provided in FIG. 18 and related embodiments, except that in this embodiment, one end of the first adjustment circuit 114 is grounded and the other end is electrically connected to the first matching circuit 113. The antenna assembly 100 includes a first antenna 110 and a second antenna 120. The first antenna 110 includes the first radiator 111, the first signal source 112, the first matching circuit 113, the first adjusting circuit 114, and the fourth radiator 115. The first radiator 111 has a first feed point 1113, the first signal source 112 is electrically connected to the first feed point 1113 through the first matching circuit 113. One end of the first adjusting circuit 114 is grounded, and the other end of the first adjusting circuit 114 is electrically connected to the first matching circuit 113. The fourth radiator 115 is electrically connected to the first matching circuit 113. The second antenna 120 includes the second radiator 121, the third radiator 125, the second signal source 122, the second matching circuit 123, and the second adjusting circuit 124. The second radiator 121 and the first radiator 111 are spaced apart from each other and coupled to each other. The second radiator 121 has a second feed point 1213, the second signal source 122 is electrically connected to the second feed point 1213 through the second matching circuit 123, and the second signal source 122 is further electrically connected to the third radiator 125 through the second matching circuit 123. One end of the second adjusting circuit 124 is grounded, and the other end of the second adjusting circuit 124 is electrically connected to the second matching circuit 123.

Referring to FIG. 20, FIG. 20 is a schematic view of the antenna assembly according to another embodiment of the present disclosure. The structure of the antenna assembly 100 provided in this embodiment is basically the same as that of the antenna assembly 100 provided in FIG. 19 and related embodiments, except that in this embodiment, one end of the second adjusting circuit 124 is grounded, and the other end is electrically connected to the second connection point 1214. Specifically, the antenna assembly 100 includes the first antenna 110 and the second antenna 120. The first antenna 110 includes the first radiator 111, the first signal source 112 having the first feed point 1113, the first matching circuit 113, and the first adjusting circuit 114. The first signal source 112 is electrically connected to the first feed point 1113 through the first matching circuit 113. One end of the first adjusting circuit 114 is grounded, and the other end of the first adjusting circuit 114 is electrically connected to the first matching circuit 113. The fourth radiator 115 is electrically connected to the first matching circuit 113. The second antenna 120 includes the second radiator 121, the third radiator 125, the second signal source 122, the second matching circuit 123, and the second adjusting circuit 124. The second radiator 121 and the first radiator 111 are spaced apart from each other and coupled to each other. The second radiator 121 has a second grounding end 1211 and a second free end 1212. The second grounding end 1211 and the second free end 1212 are opposite ends of the second radiator 121. The second grounding end 1211 is grounded. The second free end 1212 and the end (i.e., the first free end 1112) of the first radiator 111 adjacent to the second radiator 121 are spaced apart from each other and coupled to each other. The second radiator 121 further has the second feed point 1213 and the second connection point 1214 between the second free end 1212 and the second ground end 1211. The second signal source 122 is electrically connected to the second feed point 1213 through the second matching circuit 123, and the second signal source 122 is further electrically connected to the third radiator 125 through the second matching circuit 123. One end of the second adjusting circuit 124 is grounded, and the other end of the second adjusting circuit 124 is electrically connected to the second connection point 1214. In an embodiment, the second connection point 1214 is located between the second grounding end 1211 and the second feed point 1213.

Referring to FIG. 21, FIG. 21 is a schematic view of the antenna assembly according to another embodiment of the present disclosure. The structure of the antenna assembly 100 provided in this embodiment is basically the same as that of the antenna assembly 100 provided in FIG. 20 and related embodiments, except that in this embodiment, the second connection point 1214 is located between the second free end 1212 and the second feed point 1213. The antenna assembly 100 includes the first antenna 110 and the second antenna 120. The first antenna 110 includes the first radiator 111, the first signal source 112 having the first feed point 1113, the first matching circuit 113, and the first adjusting circuit 114. The first signal source 112 is electrically connected to the first feed point 1113 through the first matching circuit 113. One end of the first adjusting circuit 114 is grounded, and the other end of the first adjusting circuit 114 is electrically connected to the first matching circuit 113. The fourth radiator 115 is electrically connected to the first matching circuit 113. The second antenna 120 includes the second radiator 121, the third radiator 125, the second signal source 122, the second matching circuit 123, and the second adjusting circuit 124. The second radiator 121 and the first radiator 111 are spaced apart from each other and coupled to each other. The second radiator 121 has the second grounding end 1211 and the second free end 1212. The second grounding end 1211 and the second free end 1212 are opposite ends of the second radiator 121. The second grounding end 1211 is grounded. The second free end 1212 and the end (first free ends 1112) of the first radiator 111 adjacent to the second radiator 121 are spaced apart from each other and couple to each other. The second radiator 121 further has the second feed point 1213 and the second connection point 1214 between the second free end 1212 and the second ground end 1211. The second signal source 122 is electrically connected to the second feed point 1213 through the second matching circuit 123, and the second signal source 122 is further electrically connected to the third radiator 125 through the second matching circuit 123. One end of the second adjusting circuit 124 is grounded, and the other end of the second adjusting circuit 124 is electrically connected to the second connection point 1214. In this embodiment, the second connection point 1214 is located between the second free end 1212 and the second feed point 1213.

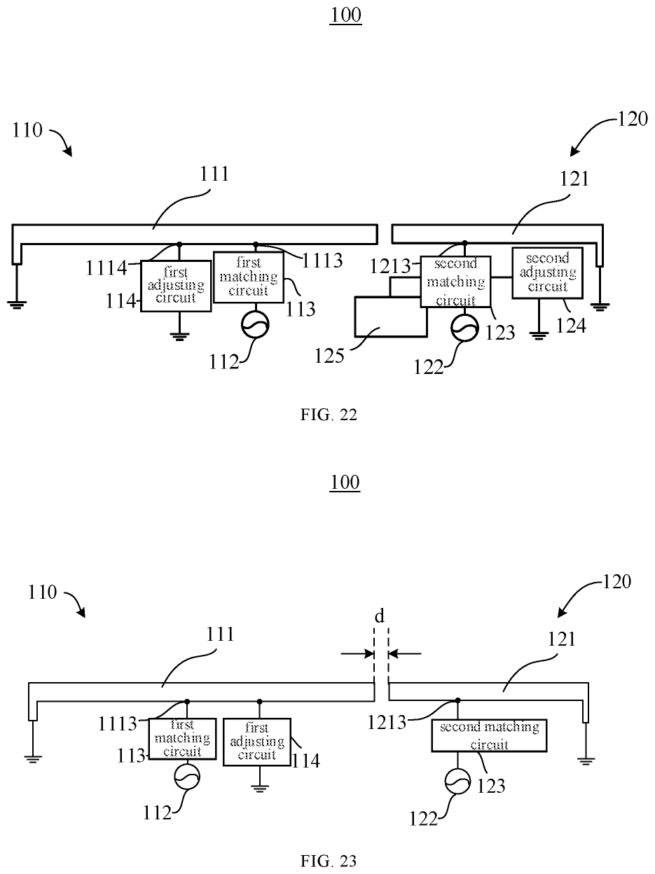

Referring to FIG. 22, FIG. 22 is a schematic view of the antenna assembly according to yet another embodiment of the present disclosure. The structure of the antenna assembly 100 provided in this embodiment is basically the same as that of the antenna assembly 100 provided in FIG. 19 and related embodiments, except that in this embodiment, the first connection point 1114 is located between the first feed point 1113 and the first free end 1112. In this embodiment, the first connection point 1114 is located between the first feed point 1113 and the first grounding end 1111. The remaining structure of the antenna assembly 100 is described with reference to FIG. 14 and related embodiments thereof.

As can be seen from the various embodiments described above, the first adjusting circuit 114 in the first antenna 110 includes a manner that one end of the first adjusting circuit 114 is electrically connected to the first connection point 1114 and the other end is grounded; alternatively, one end of the first adjusting circuit 114 is electrically connected to the first matching circuit 113 and the other end is grounded. “One end of the first adjusting circuit 114 is electrically connected to the first connection point 1114 and the other end is grounded” includes the following situations: the first connection point 1114 is located between the first feed point 1113 and the first free end 1112; alternatively, the first connection point 1114 is located between the first feed point 1113 and the first grounding end 1111. The first antenna 110 may or may not include the fourth radiator 115. When the first antenna 110 includes the fourth radiator 115, the fourth radiator 115 is electrically connected to the first matching circuit 113.

When the first connection point 1114 is located between the first feeding point 1113 and the first free end 1112, the impact of the electromagnetic wave signal supported by the second resonant mode generated by the first radiator 111 on the electromagnetic wave signals of other frequency bands supported by the antenna assembly 100 can be reduced. The first connection point 1114 can also be located between the first feeding point 1113 and the first grounding end 1111, as long as the first regulating circuit 114 can be electrically connected to the first radiator 111.

The second adjusting circuit 124 in the second antenna 120 includes a manner that one end of the second adjusting circuit 124 is electrically connected to the second connection point 1214 and the other end is grounded; alternatively, one end of the second adjusting circuit 124 is electrically connected to the second matching circuit 123 and the other end is grounded. “One end of the second adjusting circuit 124 is electrically connected to the second connection point 1214 and the other end is grounded” includes the following conditions: the second connection point 1214 is located between the second feed point 1213 and the second free end 1212; alternatively, the second connection point 1214 is located between the second feed point 1213 and the second grounding end 1211.

When the second connection point 1214 is located between the second feed point 1213 and the second free end 1212, the impact of the electromagnetic wave signal generated by the second radiator 121 on the electromagnetic wave signals of other frequency bands supported by the antenna assembly 100 can be reduced. It can be understood that the second connection point 1214 can also be located between the second feed point 1213 and the second grounding end 1211, as long as the second adjusting circuit 124 can be electrically connected to the second radiator 121.

The antenna assembly 100 includes a combination of any one of the embodiments of the first antenna 110 and any one of the embodiments of the second antenna 120.

Referring to FIG. 23, FIG. 23 is a schematic view of the size of a gap between the first radiator and the second radiator in the antenna assembly according to an embodiment of the present disclosure. The size d of the gap between the first radiator 111 and the second radiator 121 satisfies: 0.5 mm≤d≤1.5 mm.

For the antenna assembly 100, the gap d between the radiator of the first antenna 110 and the radiator of the second antenna 120 in the antenna assembly 100 satisfies: 0.5 mm≤d≤1.5 mm, to ensure a better coupling effect between the first radiator 111 and the second radiator 121. Although the dimensions of the first radiator 111 and the second radiator 121 in the antenna assembly 100 are combined with the antenna assembly 100 shown in FIG. 2 as an example in this embodiment, it should not be understood as limiting the present disclosure. The gap between the first radiator 111 and the second radiator 121 also applies to the antenna assembly 100 provided by other embodiments.

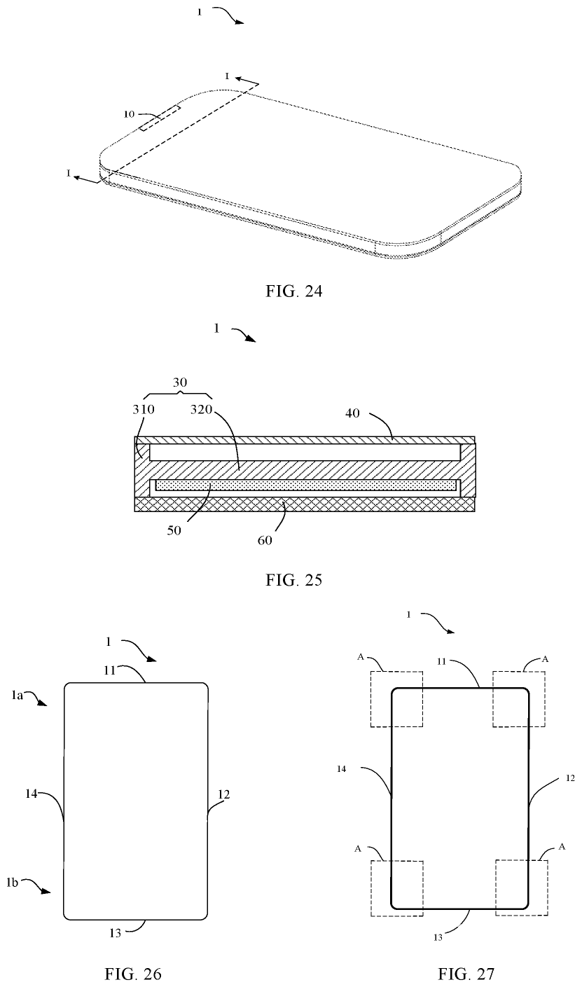

Referring to FIG. 24, FIG. 24 is a three-dimensional schematic view of the electronic device according to an embodiment of the present disclosure. The electronic device 1 includes the antenna system 10 of any of the foregoing embodiments.

Referring now to FIG. 25, FIG. 25 is a cross-sectional schematic view of the line I-I of FIG. 24 according to an embodiment of the present disclosure. In this embodiment, the electronic device 1 also includes a middle frame 30, a screen 40, a circuit board 50 and a battery cover 60. The material of the middle frame 30 is metal, such as an aluminum magnesium alloy. The middle frame 30 typically constitutes the ground of the electronic device 1. When the electronic element in the electronic device 1 needs to be grounded, the middle frame 30 may be connected to ground (GND). In addition, the ground system in the electronic device 1 includes not only the middle frame 30, but also the ground on circuit board 50 and the ground in screen 40. The screen 40 may be the display screen with the display function, or the screen 40 integrated with display and touch functions. The screen 40 is used for displaying information such as characters, images, videos and the like. The screen 40 is carried on the middle frame 30 and is located on one side of the middle frame 30. The circuit board 50 is usually also carried on the middle frame 30, and the circuit board 50 and the screen 40 are carried on two opposite sides of the middle frame 30. At least one or more of the first signal source 112, the second signal source 122, the first matching circuit 113, the second matching circuit 123, the first adjustment circuit 114, and the second adjustment circuit 124 in the antenna assembly 100 previously introduced can be provided on the circuit board 50. The battery cover 60 is arranged on the side of the circuit board 50 that is away from the middle frame 30. The battery cover 60, the middle frame 30, the circuit board 50, and the screen 40 cooperate with each other to assemble the complete electronic device 1. The structural description of electronic device 1 is only a description of one form of the structure of electronic device 1, and should not be understood as a limitation on electronic device 1, nor should it be understood as a limitation on antenna assembly 100.

When the first radiator 111 is electrically connected to the ground of the middle frame 30, the first radiator 111 can also be connected to the ground of the middle frame 30 through the connecting rib, alternatively, the first radiator 111 is also electrically connected to the ground of the middle frame 30 through the conductive elastic sheet. When the second radiator 121 is electrically connected to the ground of the middle frame 30, the second radiator 121 can also be connected to the ground of the middle frame 30 through the connecting rib, or the second radiator 121 is also electrically connected to the ground of the middle frame 30 through the conductive elastic sheet.

The middle frame 30 includes the frame body 310 and the frame 320, the frame 320 is bent and connected to the periphery of the frame body 310; and any one of the first radiator 111, the second radiator 121, the third radiator 125 and the fourth radiator 115 can be formed on the frame 320.

In other embodiments, the first radiator 111, the second radiator 121, the third radiator 125, and the fourth radiator 115 may also be formed on the frame 320; and may be an FPC antenna radiator, an LDS antenna radiator, a PDS antenna radiator, or a metal branch.

Referring to FIG. 26, FIG. 6 is a schematic view of the electronic device in an embodiment. In the present embodiment, the electronic device 1 includes a top portion 1a and a bottom portion 1b, and the first radiator 111 and the second radiator 121 of the antenna assembly 100 are both located on the top portion 1a.

The top portion 1a refers to the area located on the top of the electronic device 1 when in use. The bottom portion 1b is opposite to the top portion 1a, and is the area located on the bottom of the electronic device 1.

The electronic device 1 includes the first side 11, the second side 12, the third side 13 and the fourth side 14 which are sequentially connected end to end. The first side 11 and the third side 13 are short sides of the electronic device 1. The second side 12 and the fourth side 14 are long sides of the electronic device 1. The first side 11 and the third side 13 are opposite to each other and are spaced apart from each other. The second side 12 and the fourth side 14 are opposite to each other and are spaced apart from each other. The second side 12 is respectively connected to the first side 11 and the third side 13 in a bending way. The fourth side 14 is respectively connected to the first side 11 and the third side 13 in a bending way. The connection between the first side 11 and the second side 12, the connection between the second side 12 and the third side 13, the connection between the third side 13 and the fourth side 14, and the connection between the fourth side 14 and the first side 11 form the angle of the electronic device 1. The first side 11 is the top side, the second side 12 is the right side, the third side 13 is the bottom side, and the fourth side 14 is the left side. The angle formed by the first side 11 and the second side 12 is the top right corner, and the angle formed by the first side 11 and the fourth side 14 is the top left corner.

The top portion 1a includes three situations: the first radiator 111 and the second radiator 121 are disposed at the top left corner of the electronic device 1; alternatively, the first radiator 111 and the second radiator 121 are disposed on the top side of the electronic device 1; alternatively, the first radiator 111 and the second radiator 121 are arranged at the top right corner of the electronic device 1.

When the first radiator 111 and the second radiator 121 are arranged at the top left corner of the electronic device 1, the following situations are included: a portion of the first radiator 111 is located on the left side, the other portion of the first radiator 111 is located on the top side, and the second radiator 121 is located on the top side; alternatively, a portion of the second radiator 121 is located on the top side, another portion of the second radiator 121 is located on the left side, and the first radiator 111 is located on the left side.

When the first radiator 111 and the second radiator 121 are arranged at the top right corner of the electronic device 1, the following situations are included: a portion of the first radiator 111 is located on the top side, the other portion of the first radiator 111 is located on the right side, and the second radiator 121 is located on the right side; alternatively, a portion of the second radiator 121 is located on the right side, a portion of the second radiator 121 is located on the top side, and a portion of the first radiator 111 is located on the top side.

When the electronic device 1 is placed three-dimensionally, the top portion 1a of the electronic device 1 is generally facing away from the ground, and the bottom portion 1b of the electronic device 1 is generally close to the ground. When the first radiator 111 and the second radiator 121 are disposed on the top portion 1a, the upper hemispheres of the first antenna 110 and the second antenna 120 have good radiation efficiency, such that the first antenna 110 and the second antenna 120 have better communication efficiency. In other embodiments, the first radiator 111 and the second radiator 121 may also correspond to the bottom portion 1b of the electronic device 1. Although the upper hemisphere radiation efficiency of the first antenna 110 and the second antenna 120 is not so good when the first radiator 111 and the second radiator 121 are arranged corresponding to the bottom portion 1b of the electronic device 1, a better communication effect can be achieved as long as the upper hemisphere radiation efficiency is larger than or equal to a preset efficiency.

Referring to FIG. 27, FIG. 27 is a schematic view of the antenna system in the electronic device according to another embodiment of the present disclosure. The electronic device 1 in the embodiment includes a plurality of sides which are connected end to end in sequence. Taking the electronic device 1 including the first side 11, the second side 12, the third side 13 and the fourth side 14 which are connected end to end as an example, the first side 11 and the third side 13 are short sides of the electronic device 1, and the second side 12 and the fourth side 14 are long sides of the electronic device 1. The first side 11 and the third side 13 are opposite to each other and are spaced apart from each other. The second side 12 and the fourth side 14 are opposite to each other and spaced apart from each other, the second side 12 is respectively connected to the first side 11 and the third side 13 in the bending way, the fourth side 14 is respectively connected to the first side 11 and the third side 13 in the bending way. The connection between the first side 11 and the second side 12, the connection between the second side 12 and the third side 13, the connection between the third side 13 and the fourth side 14, and the connection between the fourth side 14 and the first side 11 form the angle A of the electronic device 1. The first radiator 111 and the second radiator 121 in the same antenna assembly 100 can correspond to any angle in the electronic device 1. The first radiator 111 and the second radiator 121 in the same antenna assembly 100 can correspond to the same angle in the electronic device 1. When the first radiator 111 and the second radiator 121 correspond to the angle of the electronic device 1, the efficiency of the first antenna 110 and the second antenna 120 is higher. In this embodiment, taking the first side 11 and the third side 13 being the short sides of the electronic device 1, and the second side 12 and the fourth side 14 being the long sides of the electronic device 1 as an example. In other embodiments, the lengths of the first side 11, the second side 12, the third side 13, and the fourth side 14 are equal. In this embodiment, four antenna assemblies 100 respectively correspond to four angles of electronic device 1, and each antenna assembly 100 corresponds to one angle, so that the antenna system 10 has a wide coverage range, thereby achieving 360° omnidirectional coverage without dead angles.

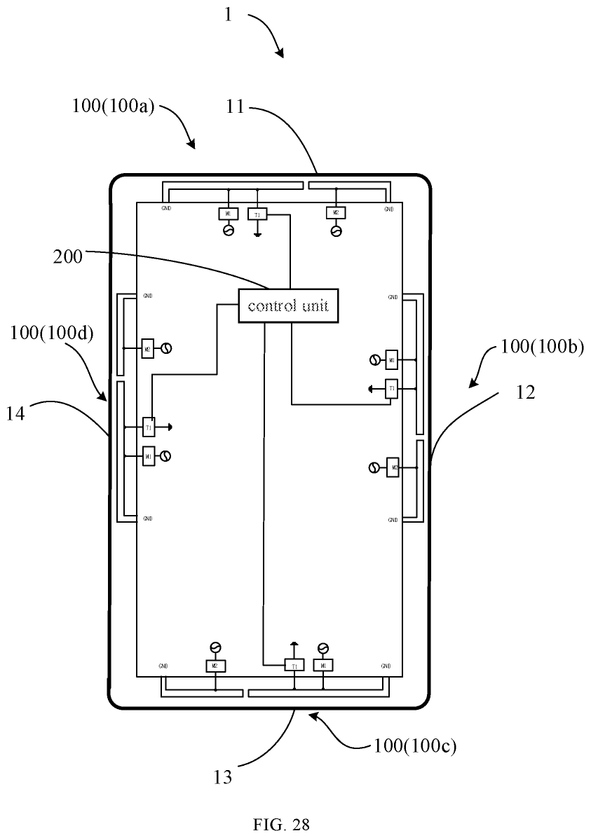

Referring to FIG. 28, FIG. 28 is a schematic illustration of the position of the antenna system in the electronic device according to another embodiment of the present disclosure. In the present embodiment, the electronic device 1 includes a plurality of sides sequentially connected end to end, each antenna assembly 100 is arranged corresponding to different sides. For example, the electronic device 1 includes the first side 11, the second side 12, the third side 13 and the fourth side 14 which are sequentially connected end to end. The first side 11 and the third side 13 are short sides of the electronic device 1, and the second side 12 and the fourth side 14 are long sides of the electronic device 1. The first side 11 and the third side 13 are opposite to each other and are spaced apart from each other. The second side 12 and the fourth side 14 are opposite to each other and spaced apart from each other. The second side 12 is respectively connected to the first side 11 and the third side 13 in the bending way, the fourth side 14 is respectively connected to the first side 11 and the third side 13 in the bending way. The antenna assembly 100a is arranged corresponding to the first side 11, the antenna assembly 100b is arranged corresponding to the second side 12, the antenna assembly 100c is arranged corresponding to the third side 13, and the antenna assembly 100d is arranged corresponding to the fourth side 14. The first antenna 110 of the antenna assembly 100a corresponding to the first side 11 and the first antenna 110 of the antenna assembly 100c corresponding to the third side 13 are adjacent to the second side 12. Alternatively, the first antenna 110 of the antenna assembly 100a corresponding to the first side 11 and the first antenna 110 of the antenna assembly 100c corresponding to the third side 13 are adjacent to the fourth side 14. Alternatively, the first antenna 110 of the antenna assembly 100a corresponding to the first side 11 is adjacent to the second side 12, and the first antenna 110 of the antenna assembly 100c corresponding to the third side 13 is adjacent to the fourth side 14. Alternatively, the first antenna 110 of the antenna assembly 100a corresponding to the first side 11 is adjacent to the fourth side 14, and the first antenna 110 of the antenna assembly 100c corresponding to the third side 13 is adjacent to the second side 12.

The first antenna 110 of the antenna assembly 100b corresponding to the second side 12 and the first antenna 110 of the antenna assembly 100d corresponding to the fourth side 14 are adjacent to the first side 11. Alternatively, the first antenna 110 of the antenna assembly 100b corresponding to the second side 12 and the first antenna 110 of the antenna assembly 100d corresponding to the fourth side 14 are adjacent to the third side 13. Alternatively, the first antenna 110 of the antenna assembly 100b corresponding to the second side 12 is adjacent to the first side 11, and the first antenna 110 of the antenna assembly 100d corresponding to the fourth side 14 is adjacent to the third side 13. Alternatively, the first antenna 110 of the antenna assembly 100b corresponding to the second side 12 is adjacent to the third side 13, and the first antenna 110 of the antenna assembly 100d corresponding to the fourth side 14 is adjacent to the first side 11.

In FIG. 3 and its corresponding embodiment, the first antenna 110 of the antenna assembly 100a corresponding to the first side 11 is adjacent to the fourth side 14, and the first antenna 110 of the antenna assembly 100c corresponding to the third side 13 is adjacent to the second side 12; and the first antenna 110 of the antenna assembly 100b corresponding to the second side 12 is adjacent to the third side 13, and the first antenna 110 of the antenna assembly 100d corresponding to the fourth side 14 is also adjacent to the third side 13, which serves as an example for illustration.

In the schematic view of the present embodiment, the first antenna 110 of the antenna assembly 100a corresponding to the first side 11 is adjacent to the fourth side 14, and the first antenna 110 of the antenna assembly 100c corresponding to the third side 13 is adjacent to the second side wall; and the first antenna 110 of the antenna assembly 100b corresponding to the second side 12 is adjacent to the first side 11, and the first antenna 110 of the antenna assembly 100d corresponding to the fourth side 14 is adjacent to the third side 13, which serves as an example for illustration.

The position of the antenna assembly 100 corresponding to each side can be adjusted, and it can be rotated 180° left, right, or up or down. In this embodiment, four antenna assemblies 100 respectively correspond to four side of electronic device 1, and each antenna assembly 100 respectively corresponds to one side, so that the antenna system 10 has a wide coverage range, thereby achieving 360° omnidirectional coverage without dead corner.

Although embodiments of the present disclosure have been shown and described above, it can be understood that the above embodiments are exemplary and cannot be understood as limitations to the present disclosure. Ordinary technical personnel in the art can make changes, modifications, substitutions, and modifications to the above embodiments within the scope of the present disclosure, and these improvements and embellishments are also considered within the scope of protection of the present disclosure.

What is claimed is:

1. An antenna system, comprising:
at least two antenna assemblies, wherein each antenna assembly comprises a first antenna comprising a first radiator, a first signal source, a first matching circuit and a first adjusting circuit; the first radiator has a first feed point; the first signal source is electrically connected to the first feed point through the first matching circuit; the first adjusting circuit is electrically connected to the first radiator or the first matching circuit, and is configured to adjust a resonant frequency point of the first antenna, so that the first antenna supports transceiving of electromagnetic wave signals in a first frequency band range; and the first frequency band range comprises at least one of a long term evolution (LTE) low frequency band and a new radio (NR) low frequency band; and
a control unit configured to control the first antenna of one antenna assembly to support the LTE low frequency band, and control the first antenna of the other antenna assembly to support the NR low frequency band, so as to implement LTE NR double connection (ENDC) of the LTE low frequency band and the NR low frequency band.

2. The antenna system as claimed in claim 1, wherein the antenna system comprises four antenna assemblies, the control unit is configured to control one of two antenna assemblies in the four antenna assemblies to support the same LTE low frequency band, or control two antenna assemblies in the four antenna assemblies to jointly support the same LTE low frequency band; and control one of the other two antenna assemblies in the four antenna assemblies to support the same NR low frequency band, or control the other two antenna assemblies in the four antenna assemblies to jointly support the same NR low frequency band.

3. The antenna system as claimed in claim 2, wherein the control unit is configured to adjust the first adjusting circuit of at least one first antenna in the two antenna assemblies, to adjust the LTE low frequency band commonly supported by the two antenna assemblies; the control unit is further configured to adjust the first adjusting circuit of at least one first antenna in the other two antenna assemblies, to adjust the NR low frequency band commonly supported by the other two antenna assemblies, such that the antenna system supports a first ENDC combination, a second ENDC combination, and a third ENDC combination; and the control unit is further configured to control the antenna system to switch between the first ENDC combination, the second ENDC combination, and the third ENDC combination.

4. The antenna system as claimed in claim 3, wherein the first ENDC combination comprises B20+N28, the second ENDC combination comprises B20+N8, and the third ENDC combination comprises B28+N5.

5. The antenna system as claimed in claim 1, wherein the first radiator has a first free end and a first grounding end opposite to first free end, and the first radiator also comprises a first connection point; the first feed point and the first connection point are spaced apart from each other between the first free end and the first grounding end; and when the first adjusting circuit is electrically connected to the first radiator, the first adjusting circuit is electrically connected to the first connection point.

6. The antenna system as claimed in claim 1, wherein each of the at least two antenna assemblies further comprises:
a second antenna comprising a second radiator, a second signal source, and a second matching circuit; the second radiator and the first radiator are spaced apart from each other and coupled to each other; the second radiator has a second feed point, and the second signal source is electrically connected to the second feed point through the second matching circuit; the second antenna is configured to support transceiving of electromagnetic wave signals in a second frequency band range and a third frequency band range; and the second frequency band range comprises a middle high band (MHB) frequency band, and the third frequency band range comprises an ultra high band (UHB) frequency band.

7. The antenna system as claimed in claim 6, wherein the first antenna and the second antenna are jointly used for realizing ENDC and carrier aggregation (CA) in a frequency band range of 1000 MHz to 6000 MHz.

8. The antenna system as claimed in claim 6, wherein the antenna system comprises four antenna assemblies; and the control unit is configured to control the four antenna assemblies to realize CA of the MHB frequency band and the MHB frequency band, or 4*4 multiple input multiple output (MIMO) of ENDC of the MHB frequency band and the UHB frequency band.

9. The antenna system as claimed in claim 8, wherein the second antenna further comprises a second adjusting circuit, the second adjusting circuit is electrically connected to the second radiator or the second matching circuit, and the second adjusting circuit is configured to adjust the resonant frequency point of the second antenna.

10. The antenna system as claimed in claim 9, wherein the second radiator has a second free end and a second grounding end opposite to the second free end, and the second free end and the first radiator are spaced apart from each other and coupled to each other; the second radiator further comprises a second connection point, and the second feed point and the second connection point are spaced apart from each other between the second free end and the second grounding end; and when the second adjusting circuit is electrically connected to the second radiator, the second adjusting circuit is electrically connected to the second connection point.

11. The antenna system as claimed in claim 10, wherein the second connection point is located between the second free end and the second feed point; or, the second connection point is located between the second feed point and the second grounding end.

12. The antenna system as claimed in claim 6, wherein the antenna system has a first resonance mode, a second resonance mode, a third resonance mode and a fourth resonance mode, to cover the transceiving of the electromagnetic wave signals in the second frequency band range and the third frequency band range.

13. The antenna system as claimed in claim 12, wherein each of the at least two antenna assemblies further comprises a third radiator, and the third radiator is electrically connected to the second matching circuit; and at least one of the first resonance mode, the second resonance mode, the third resonance mode, and the fourth resonance mode is generated by the third radiator.

14. The antenna system as claimed in claim 13, wherein when one end of the first adjusting circuit is grounded, and the other end is connected to the first connection point, the first resonance mode is generated from the second grounding end to the second free end of the second radiator, the second resonance mode is generated from the first connection point of the first adjusting circuit and the first radiator to the first free end, the third resonance mode is generated from the second feed point of the second radiator to the second free end, and the third radiator generates the fourth resonance mode.

15. The antenna system as claimed in claim 14, wherein the first resonance mode is a fundamental mode that the second antenna operates from the second grounding end to the second free end of the second radiator, the second resonance mode is a fundamental mode that the first antenna operates from the first connection point of the first adjusting circuit and the first radiator to the first free end, the third resonance mode is a fundamental mode that the second antenna operates from the second feed point of the second radiator to the second free end, and the fourth resonance mode is a fundamental mode that the second antenna operates in the third radiator.

16. The antenna system as claimed in claim 12, wherein when one end of the first adjusting circuit is grounded and the other end is connected to the first connection point, a fundamental mode from the second grounding end to the second free end of the second radiator generates the first resonance mode, a fundamental mode from the first connection point of the first adjusting circuit and the first radiator to the first free end generates the second resonance mode, a fundamental mode from the second feed point of the second radiator to the second free end generates the third resonance mode, and a high order mode from the first connection point of the first adjusting circuit and the first radiator to the first free end generates the fourth resonance mode.

17. An electronic device, comprising:
an antenna system, comprising:
at least two antenna assemblies, wherein each antenna assembly comprises a first antenna comprising a first radiator, a first signal source, a first matching circuit and a first adjusting circuit; the first radiator has a first feed point; the first signal source is electrically connected to the first feed point through the first matching circuit; the first adjusting circuit is electrically connected to the first radiator or the first matching circuit, and is configured to adjust a resonant frequency point of the first antenna, so that the first antenna supports transceiving of electromagnetic wave signals in a first frequency band range; and the first frequency band range comprises at least one of a long term evolution (LTE) low frequency band and a new radio (NR) low frequency band; and
a control unit configured to control the first antenna of one antenna assembly to support the LTE low frequency band, and control the first antenna of the other antenna assembly to support the NR low frequency band, so as to implement LTE NR double connection (ENDC) of the LTE low frequency band and the NR low frequency band.

18. The electronic device as claimed in claim 17, wherein the electronic device comprises a plurality of sides sequentially connected end to end, and each antenna assembly is arranged corresponding to a different side.

19. The electronic device as claimed in claim 18, wherein the electronic device comprises a first side, a second side, a third side and a fourth side sequentially connected end to end; the first side is opposite to and spaced apart from the third side, and the second side is opposite to and spaced apart from the fourth side; the first antenna of the antenna assembly corresponding to the first side and the first antenna of the antenna assembly corresponding to the third side are adjacent to the second side;
or, the first antenna of the antenna assembly corresponding to the first side and the first antenna of the antenna assembly corresponding to the third side are adjacent to the fourth side;
or, the first antenna of the antenna assembly corresponding to the first side is adjacent to the second side, and the first antenna of the antenna assembly corresponding to the third side is adjacent to the fourth side;
or, the first antenna of the antenna assembly corresponding to the first side is adjacent to the fourth side, and the first antenna of the antenna assembly corresponding to the third side is adjacent to the second side.

20. The electronic device as claimed in claim 19, wherein the first antenna of the antenna assembly corresponding to the second side and the first antenna of the antenna assembly corresponding to the fourth side are adjacent to the first side;
or, the first antenna of the antenna assembly corresponding to the second side and the first antenna of the antenna assembly corresponding to the fourth side are adjacent to the third side;
or, the first antenna of the antenna assembly corresponding to the second side is adjacent to the first side, and the first antenna of the antenna assembly corresponding to the fourth side is adjacent to the third side;
or, the first antenna of the antenna assembly corresponding to the second side is adjacent to the third side, and the first antenna of the antenna assembly corresponding to the fourth side is adjacent to the first side.
